(19) United States
(12) Patent Application Publication
(10) Pub. No.: US 2024/0418263 A1
(43) Pub. Date: Dec. 19, 2024

(54) LINEAR SEALING COMPONENTS AND METHODS AND COMPOSITIONS FOR ADDITIVELY MANUFACTURING THEREOF

(71) Applicant: PPG Industries Ohio, Inc., Cleveland, OH (US)

(72) Inventors: Andrew P. Loughner, Pittsburgh, PA (US); Cynthia Kutchko, Pittsburgh, PA (US); Ion Pelinescu, Wexford, PA (US); Yong Han Yeong, Valley Village, CA (US); Bret M. Boyle, Pittsburgh, PA (US); Shane X. Peng, Valencia, CA (US); Nagarajan Srivatsan, Diamond Bar, CA (US)

(73) Assignee: PPG Industries Ohio, Inc., Cleveland, OH (US)

(21) Appl. No.: 18/708,346

(22) PCT Filed: Nov. 8, 2022
(86) PCT No.: PCT/US2022/079426

§ 371 Date: May 8, 2024

Related U.S. Application Data
(60) Provisional application No. 63/277,646, filed on Nov. 10, 2021.

(51) Int. Cl. F16J 15/02; B33Y 70/00; B33Y 80/00

(52) U.S. Cl. CPC F16J 15/027; B33Y 70/00; B33Y 80/00

(57) ABSTRACT

Aspects of the disclosure relate to a scaling component comprising: a first recess and a second recess, the first recess and the second recess defining a center line; a first volume on a first side of the center line; a second volume on a second side of the center line; and a third volume between the first recess and the second recess such that the center line runs through the third volume. The first recess is outlined by a first recess opening, a first tip section of the first volume, a second tip section of the second volume, and a first wall of the third volume. The second recess is outlined by a second recess opening, a third tip section of the first volume, a fourth tip section of the second volume, and a second wall of the third volume.

### CROSS-REFERENCE TO RELATED APPLICATIONS

This application claims the benefit under 35 U.S.C. § 119(e) of U.S. Provisional Application No. 63/277,646, filed on Nov. 10, 2021 which is incorporated by reference in its entirety.

### FIELD OF THE INVENTION

The present disclosure relates to linear sealing components and methods and compositions for additively manufacturing thereof. The present disclosure further relates to sealing components that may have flame retardant and/or acoustic dampening properties and methods and compositions for additively manufacturing thereof. The linear sealing components may be used in aerospace applications.

### BACKGROUND

Aircraft require highly precise construction and fit of their structural components. A slight mismatch can lead to physical gaps between components. Even slightly mismatched aircraft interior structural components may lead to inferior acoustic dampening properties between the cabin and other areas such as the aircraft avionics bay, baggage compartments, and landing gear wheel wells. In particularly, noise can travel from the noisy regions of the aircraft through the physical gaps and into the cabin area, thus creating noise pollution. Currently, insulation tapes and foams are typically manually inserted into physical gaps to improve barrier properties, which are marginally effective and non-satisfactory. The ineffectiveness may at least partly be attributed to poor sealer properties, poor sealer-component interface, and varying gap sizes.

What is needed is an improvement over the foregoing.

### SUMMARY

The present disclosure relates to an additively manufactured sealing component. An additively manufactured sealing component can include: a first recess and a second recess opposite from the first recess, the first recess and the second recess defining a center line; a first volume on a first side of the center line; a second volume on a second side of the center line; and a third volume between the first recess and the second recess such that the center line runs through the third volume. The first recess may be outlined by a first recess opening, a first tip section of the first volume, a second tip section of the second volume, and a first wall of the third volume. The second recess can be outlined by a second recess opening, a third tip section of the first volume, a fourth tip section of the second volume, and a second wall of the third volume. The elongated body may comprise a thermoset polymer formed by: forming a coreactive mixture by at least mixing at least a first co-reactive component and a second co-reactive component; depositing the reactive mixture layer-by-layer to form the elongated body; and curing the deposited reactive mixture via an actinic radiation source.

### DESCRIPTION OF THE DRAWINGS

The drawings described herein are for illustration purposes only. The drawings are not intended to limit the scope of the present disclosure.

FIG. 1 is a diagram showing an apparatus for additively manufacturing a linear sealing component.

FIG. 2A is an image showing a linear sealing component according to a first embodiment.

FIG. 2B is an image showing the linear sealing component of FIG. 2A fit in a ½ inch panel gap between ⅛ inch panels.

FIG. 3A is an image showing a linear sealing component of a second embodiment fit in a ⅛ inch panel gap between ⅛ inch panels.

FIG. 3B is an image showing the linear sealing component of FIG. 3A fit in a ½ inch panel gap between ⅜ inch panels.

FIG. 4 is a diagram showing a method for additively manufacturing a linear sealing component.

FIG. 5 is a diagram showing an acoustic test apparatus.

FIG. 6 is a graph showing sound pressure level frequency spectrum data with and without a linear sealing component installed.

FIG. 7 is a graph showing overall sound pressure levels with and without a linear sealing component installed.

FIG. 8A is a graph showing viscosities of coreactive mixtures at a predetermined shear rate range.

FIG. 8B is a graph showing after-shear viscosities of coreactive mixtures over time.

FIG. 9 is a diagram showing dimensions of a linear sealing component.

### DETAILED DESCRIPTION

### Definitions

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

“Alkanediyl” refers to a diradical of a saturated, branched or straight-chain, acyclic hydrocarbon group, having from 1 to 18 carbon atoms (C₁₋₁₈), from 1 to 14 carbon atoms (C₁₋₁₄), from 1 to 6 carbon atoms (C₁₋₆), from 1 to 4 carbon atoms (C₁₋₄), or from 1 to 3 hydrocarbon atoms (C₁₋₃). An alkanediyl can be C₂₋₁₄ alkanediyl, C₂₋₁₀ alkanediyl, C₂₋₈ alkanediyl, C₂₋₆ alkanediyl, C₂₋₄ alkanediyl, or C₂₋₃ alkanediyl. Alkanediyl groups may include methane-diyl (—CH₂—), ethane-1,2-diyl (—CH₂CH₂—), propane-1,3-diyl and iso-propane-1,2-diyl (e.g., —CH₂CH₂CH₂— and —CH(CH₃)CH₂—), butane-1,4-diyl (—CH₂CH₂CH₂CH₂—), pentane-1,5-diyl (—CH₂CH₂CH₂CH₂CH₂—), hexane-1,6-diyl (—CH₂CH₂CH₂CH₂CH₂CH₂—), heptane-1,7-diyl, octane-1,8-diyl, nonane-1,9-diyl, decane-1,10-diyl, and dodecane-1,12-diyl.

“Alkanecycloalkane” refers to a saturated hydrocarbon group having one or more cycloalkyl and/or cycloalkanediyl groups and one or more alkyl and/or alkanediyl groups, where cycloalkyl, cycloalkanediyl, alkyl, and alkanediyl are defined herein. Each cycloalkyl and/or cycloalkanediyl group(s) can be C₃₋₆, C₅₋₆, cyclohexyl or cyclohexanediyl. Each alkyl and/or alkanediyl group(s) can be C₁₋₆, C₁₋₄, C₁₋₃, methyl, methanediyl, ethyl, or ethane-1,2-diyl. An alkanecycloalkane group can be C₄₋₁₈ alkanecycloalkane, C₄₋₁₆ alkanecycloalkane, C₄₋₁₂ alkanecycloalkane, C₄₋₈ alkanecycloalkane, C₆₋₁₂ alkanecycloalkane, C₆₋₁₀ alkanecycloalkane, or C₆₋₉ alkanecycloalkane. Alkanecycloalkane groups may include 1,1,3,3-tetramethylcyclohexane and cyclohexylmethane.

“Alkanecycloalkanediyl” refers to a diradical of an alkanecycloalkane group. An alkanecycloalkanediyl group can be, C₄₋₁₈ alkanecycloalkanediyl, C₄₋₁₆ alkanecycloalkanediyl, C₄₋₁₂ alkanecycloalkanediyl, C₄₋₈ alkanecycloalkanediyl, C₆₋₁₂ alkanecycloalkanediyl, C₆₋₁₀ alkanecycloalkanediyl, or C₆₋₉ alkanecycloalkanediyl. Alkanecycloalkanediyl groups may include 1,1,3,3-tetramethylcyclohexane-1,5-diyl and cyclohexylmethane-4,4′-diyl.

“Alkenyl” group refers to the structure —CR═C(R)₂ where the alkenyl group is a terminal group and is bonded to a larger molecule. In such cases, each R may independently comprise hydrogen and C₁₋₃ alkyl. Each R can be hydrogen and an alkenyl group can have the structure —CH═CH₂.

“Alkoxy” refers to a —OR group where R is alkyl as defined herein. Exemplary alkoxy groups can include methoxy, ethoxy, n-propoxy, isopropoxy, and n-butoxy. An alkoxy group can be C₁₋₈ alkoxy, C₁₋₆ alkoxy, C₁₋₄ alkoxy, or C₁₋₃ alkoxy.

“Alkyl” refers to a monoradical of a saturated, branched or straight-chain, acyclic hydrocarbon group having from 1 to 20 carbon atoms, from 1 to 10 carbon atoms, from 1 to 6 carbon atoms, from 1 to 4 carbon atoms, or from 1 to 3 carbon atoms. An alkyl group can be C₁₋₆ alkyl, C₁₋₄ alkyl, or C₁₋₃ alkyl. Exemplary alkyl groups may include methyl, ethyl, n-propyl, iso-propyl, n-butyl, iso-butyl, tert-butyl, n-hexyl, n-decyl, and tetradecyl. An alkyl group can be, C₁₋₆ alkyl, C₁₋₄ alkyl, and C₁₋₃ alkyl.

“Arenediyl” refers to diradical monocyclic or polycyclic aromatic group. Exemplary arenediyl groups may include benzene-diyl and naphthalene-diyl. An arenediyl group can be C₆₋₁₂ arenediyl, C₆₋₁₀ arenediyl, C₆₋₉ arenediyl, or benzene-diyl.

“Cycloalkanediyl” refers to a diradical saturated monocyclic or polycyclic hydrocarbon group. A cycloalkanediyl group can be C₃₋₁₂ cycloalkanediyl, C₃₋₈ cycloalkanediyl, C₃₋₆ cycloalkanediyl, or C_{5S-6} cycloalkanediyl. Exemplary cycloalkanediyl groups may include cyclohexane-1,4-diyl, cyclohexane-1,3-diyl and cyclohexane-1,2-diyl.

“Cycloalkyl” refers to a saturated monocyclic or polycyclic hydrocarbon mono-radical group. A cycloalkyl group can be C₃₋₁₂ cycloalkyl, C₃₋₈ cycloalkyl, C₃₋₆ cycloalkyl, or C₅₋₆ cycloalkyl.

“Heteroalkanediyl” refers to an alkanediyl group in which one or more of the carbon atoms are replaced with a heteroatom, such as N, O, S, or P. In a heteroalkanediyl, the one or more heteroatoms can be N or O.

“Heterocycloalkanediyl” refers to a cycloalkanediyl group in which one or more of the carbon atoms are replaced with a heteroatom, such as N, O, S, or P. In a heterocycloalkanediyl, the one or more heteroatoms can be N or O.

A “backbone” of a prepolymer refers to the segment between the reactive terminal groups. A prepolymer backbone typically includes repeating subunits such as the backbone of a polythiol HS—[R]ₙ—SH is —[R]ₙ—.

“A coreactive composition” refers to a composition comprising two or more coreactive compounds capable of reacting at a temperature such as less than 50° C., less than 40° C., less than 30° C., or less than 20° C. The reaction between the two or more compounds may be initiated by combining and mixing the two or more coreactive compounds and/or by exposing a coreactive composition comprising the two or more coreactive compounds to actinic radiation. A coreactive composition can be formed by combining and mixing a first reactive component comprising a first reactive compounds with a second reactive component comprising a second reactive compounds, wherein the first reactive compound can react with the second reactive compound.

A “core” of a polyfunctionalizing agent B(—V)_{z} refers to the moiety B. A “core” of a compound or a polymer refers to the segment between the reactive terminal groups such as the core of a polythiol HS—R—SH will be —R—. A core of a compound or prepolymer can also be referred to as a backbone of a compound or a backbone of a prepolymer. A core of a polyfunctionalizing agent can be an atom or a structure such as a cycloalkane, a substituted cycloalkane, heterocycloalkane, substituted heterocycloalkane, arene, substituted arene, heteroarene, or substituted heteroarene from which moieties having a reactive functional are bonded.

“Cure rate” and/or “cure time” may refer to the duration from when the curing reaction of a coreactive composition is first initiated by combining and mixing to coreactive components to form the coreactive composition and/or by exposing a coreactive composition to actinic radiation, until a layer prepared from the coreactive composition exhibits a hardness of Shore 30A at conditions of 25° C. and 50% RH. For an actinic radiation-curable composition the cure time refers to the duration from when the coreactive composition is first exposed to actinic radiation to the time when a layer prepared from the exposed coreactive composition exhibits a hardness of Shore 30A at conditions of 25° C. and 50% RH.

A dash (“-”) that is not between two letters or symbols is used to indicate a point of bonding for a substituent or between two atoms such as —CONH₂ is attached through the carbon atom.

“Derived from” as in “a moiety derived from a compound” refers to a moiety that is generated upon reaction of a parent compound with a reactant. For instance, a bis(alkenyl) compound CH₂=CH—R—CH═CH₂ can react with another compound such as a compound having thiol groups to produce the moiety —(CH₂)₂—R—(CH₂)₂—, which is derived from the reaction of the alkenyl groups with the thiol groups. As another instance, for a parent diisocyanate having the structure O═C═N—R—N═C═O, a moiety derived from the diisocyanate has the structure —C(O)—NH—R—NH—C(O)—.

“Derived from the reaction of —V with a thiol” refers to a moiety —V′— that results from the reaction of a thiol group with a moiety comprising a terminal group reactive with a thiol group. For instance, a group V— can comprise CH₂=CH—CH₂—O—, where the terminal alkenyl group CH₂=CH— is reactive with a thiol group —SH. Upon reaction with a thiol group, the moiety —V′— is —CH₂—CH₂—CH₂—O—.

Glass transition temperature T_{g} is determined by dynamic mechanical analysis (DMA) using a TA Instruments Q800 apparatus with a frequency of 1 Hz, an amplitude of 20 microns, and a temperature ramp of −80° C. to 25° C., with the T_{g} identified as the peak of the tan δ curve.

A monomer may refer to a low molecular weight compound and can have a molecular weight of less than 1,000 Da, less than 800 Da less than 600 Da, less than 500 Da, less than 400 Da, or less than 300 Da. A monomer can have a molecular weight from 100 Da to 1,000 Da, from 100 Da to 800 Da, from 100 Da to 600 Da, from 150 Da, to 550 Da, or from 200 Da to 500 Da. A monomer can have a molecular weight greater than 100 Da, greater than 200 Da, greater than 300 Da, greater than 400 Da, greater than 500 Da, greater than 600 Da, or greater than 800 Da. A monomer can have a reactive functionality of two or more such as from 2 to 6, from 2 to 5, or from 2 to 4. A monomer can have a functionality of 2, 3, 4, 5, 6, or a combination of any of the foregoing. A monomer can have an average reactive functionality such as from 2 to 6, from 2 to 5, from 2 to 4, from 2 to 3, from 2.1 to 2.8, or from 2.2 to 2.6.

A “polyalkenyl” refers to a compound having at least two alkenyl groups. The at least two alkenyl groups can be terminal alkenyl groups and such polyalkenyls can be referred to as alkenyl-terminated compounds. Alkenyl groups can also be pendent alkenyl groups. A polyalkenyl can be a dialkenyl, having two alkenyl groups. A polyalkenyl can have more than two alkenyl groups such as from three to six alkenyl groups. A polyalkenyl can comprise a single type of polyalkenyl, can be a combination of polyalkenyls having the same alkenyl functionality, or can be a combination of polyalkenyls having different alkenyl functionalities.

“Prepolymer” refers to homopolymers and copolymers. For thiol-terminated prepolymers, molecular weights are number average molecular weights “Mn” as determined by end group analysis using iodine titration. For prepolymers that are not thiol-terminated, the number average molecular weights are determined by gel permeation chromatography using polystyrene standards. A prepolymer comprises a backbone and terminal reactive groups capable of reacting with another compound such as a curing agent or crosslinker to form a cured polymer. A prepolymer includes multiple repeating subunits bonded to each other than can be the same or different. The multiple repeating subunits make up the backbone of the prepolymer.

A polyfunctionalizing agent can have the structure of Formula (1):

$${B ( - V )}_{z} \qquad ( 1 )$$

where B¹ is the core of the polyfunctionalizing agent, each V is a moiety terminated in a reactive functional group such as a thiol group, an alkenyl group, an epoxy group, an isocyanate group, or a Michael acceptor group, and z is an integer from 3 to 6, such as 3, 4, 5, or 6. In polyfunctionalizing agents of Formula (1), each —V can have the structure such as —R—SH or —R—CH═CH₂, where R can be C₂₋₁₀ alkanediyl, C₂₋₁₀ heteroalkanediyl, substituted C₂₋₁₀ alkanediyl, or substituted C₂₋₁₀ heteroalkanediyl. When the moiety V is reacted with another compound the moiety —V¹— results and is said to be derived from the reaction with the other compound. For instance, when V is —R—CH═CH₂ and is reacted with a thiol group, the moiety V¹ is —R—CH₂—CH₂— can be derived from the reaction.

Specific gravity is determined according to ASTM D1475.

Shore A hardness is measured using a Type A durometer in accordance with ASTM D2240.

“Substituted” refers to a group in which one or more hydrogen atoms are each independently replaced with the same or different substituent(s). A substituent can comprise halogen, —S(O)₂OH, —S(O)₂, —SH, —SR where R is C₁₋₆ alkyl, —COOH, —NO₂, —NR₂ where each R independently comprises hydrogen and C₁₋₃ alkyl, —CN, =O, C₁₋₁₀ alkyl, —CF₃, —OH, phenyl, C₂₋₆ heteroalkyl, C₅₋₆ heteroaryl, C₁₋₁₀ alkoxy, or —COR where R is C₁₋₁₀ alkyl. A substituent can be —OH, —NH₂, or C₁₋₁₀ alkyl.

“Tack free time” refers to the duration from the time when the curing reaction of a coreactive composition is first initiated to the time when a layer prepared from the coreactive composition is no longer tack free, where tack free is determined by applying a polyethylene sheet to the surface of the layer with hand pressure and observing whether sealant adheres to the surface of the polyethylene sheet, where the layer is considered to be tack free if the polyethylene sheet separates easily from the layer. For an actinic radiation-curable coreactive composition, the tack free time refers to the time from when the coreactive composition is exposed to actinic radiation to the time when a layer prepared from the coreactive composition is no longer tack free.

Tensile strength and elongation are measured according to AMS 3279.

“Transmissive” refers to the ability to transmit a portion of the electromagnetic spectrum within the range of 360 nm to 750 nm, of greater than 20%, greater than 30%, greater than 40%, or greater than 50% of the incident radiation.

Reference is now made to certain compounds, compositions, apparatus, and methods of the present disclosure. The disclosed compounds, compositions, apparatus, and methods are not intended to be limiting of the claims. To the contrary, the claims are intended to cover all alternatives, modifications, and equivalents.

### Introduction

Methods provided by the present disclosure comprise methods of fabricating linear sealing components using three-dimensional (3D) printing. Three-dimensional printing includes a variety of robotic manufacturing methods in which processor-controlled robotic methods are used to form three-dimensional articles. A linear sealing component can be fabricated by conveying a first co-reactive component and a second co-reactive component into a mixing chamber, mixing the first co-reactive component and the second co-reactive component to form a reactive mixture, depositing the reactive mixture layer-by-layer to form an elongated body, and curing the deposited reactive mixture via an actinic radiation source. In various instances, the first co-reactive component includes a thiol-terminated polythioether, whereas the second co-reactive component includes a polyvinyl ether. A linear sealing component fabricated according to the present disclosure may include a first recess and a second recess opposite from the first recess, a first volume on a first side of a center line defined by the first recess and the second recess, a second volume on a second side of the center line, and a third volume between the first recess and the second recess such that the center line runs through the third volume. The first recess can be outlined by a first recess opening, a first tip section of the first volume, a second tip section of the second volume, and a first wall of the third volume. The second recess can be outlined by a second recess opening, a third tip section of the first volume, a fourth tip section of the second volume, and a second wall of the third volume. The elongated body can comprise a thermoset polymer formed by: forming a coreactive mixture by at least mixing at least a first co-reactive component and a second co-reactive component; depositing the reactive mixture layer-by-layer to form the elongated body; and curing the deposited reactive mixture via an actinic radiation source.

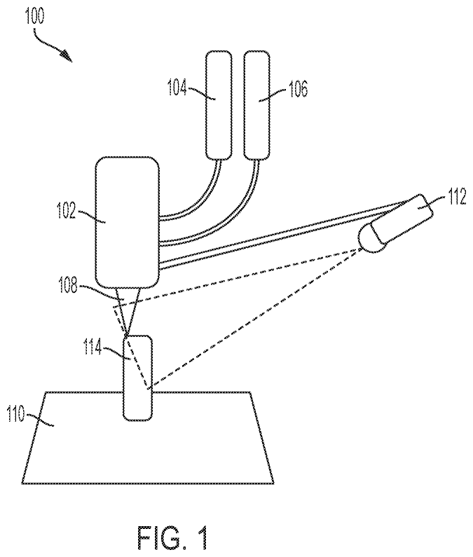

A 3D printing apparatus 100 is shown in FIG. 1. FIG. 1 shows the printing apparatus 100 including a mixing chamber 102, a first reactant reservoir 104, a second reactant reservoir 106, a extrusion tip 108, a printing platform 110, and a radiation source 112. Mixing chamber 102 may be fluidically coupled to first reactant reservoir 104 and second reactant reservoir 106 such that a first reactant stored in first reactant reservoir 104 and a second reactant stored in second reactant reservoir 106 may be conveyed into mixing chamber 102 to be mixed. Once mixed, the reactant mixture may be deposited onto printing platform 110 via extrusion tip 108 to form a printed body 114. The printed body 114 may be cured or further cured by radiation source 112, which may provide actinic radiation during deposition and/or after deposition of the reactant mixture.

### Linear Sealing Components

### Arrangement 1—Closed Core Double Crescent

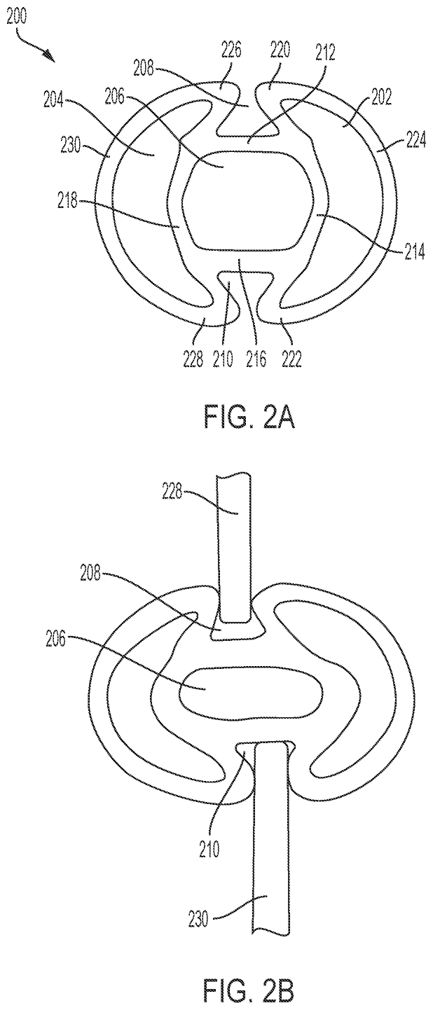

Linear sealing components are linear structures that fit in physical gaps between structures. The linear sealing component may fit between panel gaps between two or more panels (e.g., cabin panels of an aircraft). A cross-sectional view of a linear sealing component 200 is shown in FIG. 2A and FIG. 2B.

FIG. 2A shows the linear sealing component 200 having a first volume 202, a second volume 204, a third volume 206, a first crescent recess 208, and a second crescent recess 210. A reference center line may be defined by first crescent recess 208 and second crescent recess 210 such that it runs through third volume 206. As shown, the third volume 206 is centrally positioned and defined by a first inner wall 212, a second inner wall 214, a third inner wall 216, and a fourth inner wall 218. The first volume 202 is positioned on a first side of the reference center line and defined by a first exterior wall 224, the second inner wall 214, a first tip section 220, and a second tip section 222. The second volume 204 is positioned on a second side of the reference center line and defined by a second exterior wall 230, the fourth inner wall 218, a third tip section 226, and a fourth tip section 228. The first crescent recess 208 is defined by first inner wall 212, first tip section 220, and third tip section 226. The second crescent recess 210 is defined by third inner wall 216, second tip section 222, and fourth tip section 228. Linear sealing component's ability to secure panels with at least three points of contact may attribute to the superior sound dampening performance. A crescent recess may be referred to as a recess.

FIG. 2B shows linear sealing component 200 of FIG. 2A being fitted into a panel gap between a first panel 228 and a second panel 230. Specifically, first panel 228 is received by first crescent recess 208 and secured (e.g., via friction and/or pressure) by first inner wall 212, first tip section 220, and third tip section 226. Second panel 230 is received by second crescent recess 210 and secured (e.g., via friction and/or pressure) by third inner wall 216, second tip section 222, and fourth tip section 228. In certain instances, a panel received in a crescent recess need not be in contact (e.g., continuous contact) with all three points of contact to maintain a seal. Panel 228 as depicted may not be in direct contact with the inner call 212 yet is secured by tip sections 220, 226 to form an effective seal. Each of first crescent recess 208 and second crescent recess 210 may be triangular with an opening that is narrower than a base near an inner wall. As depicted, first crescent recess 208's opening is between linear sealing components of the present disclosure and may be configured to receive panels that are not in-plane. As depicted, linear sealing component 200 couples (e.g., via elastic deformation) first panel 228 and second panel 230 when the panels are out-of-plane. Linear sealing component 200 may receive in-plane panels as well. Additionally, linear sealing components of the present disclosure may be configured to receive panels spaced apart at various gap sizes, such as from 0 to ½ inch and/or from 0 to 100% of the recess-to-recess distance of component 200. As depicted, linear sealing component 200 may couple (e.g., via elastic deformation) first panel 228 and second panel 230 when the panel gap is smaller than the natural first crescent recess-to-second crescent recess distance of the linear sealing component 200. Linear sealing component 200 may receive panels of thicknesses from 1-1.5 times its recess opening size.

### Arrangment 2—Open Core Double Crescent

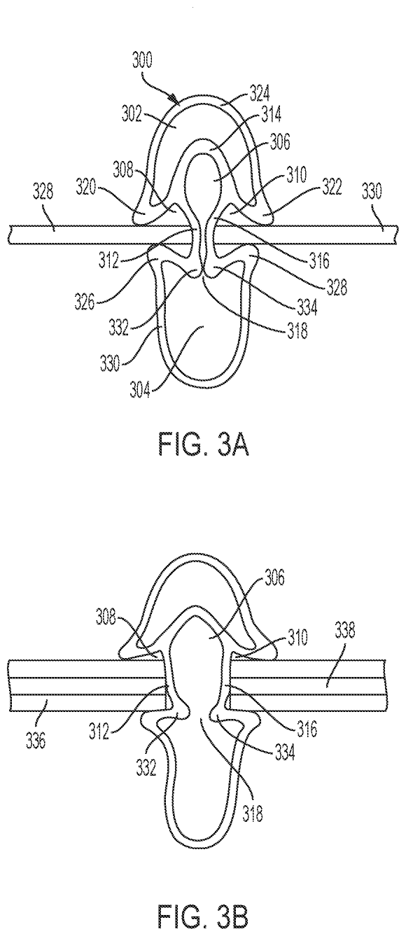

FIG. 3A shows a linear sealing component 300 having an open core (e.g., third volume with three walls and one opening) and extended internal walls (e.g., at least two inner walls). As depicted, linear sealing component 300 has a first volume 302, a second volume 304, a third volume 306, a first crescent recess 308, and a second crescent recess 310. A reference center line may be defined by first crescent recess 308 and second crescent recess 310 such that it runs through third volume 306. As shown, the third volume 306 is centrally positioned and defined by a first inner wall 312, a second inner wall 314, a third inner wall 316, and an inner opening 318. The first volume 302 is positioned on a first side of the reference center line and defined by a first exterior wall 324, the second inner wall 314, a first tip section 320, and a second tip section 322. The second volume 304 is positioned on a second side of the reference center line and defined by a second exterior wall 330, the inner opening 318, a third tip section 326, and a fourth tip section 328. The first crescent recess 308 is defined by first inner wall 312, first tip section 320, and third tip section 326. The second crescent recess 310 is defined by third inner wall 316, second tip section 322, and fourth tip section 328.

As shown, linear sealing component 300 may be fitted into a panel gap between a first panel 328 and a second panel 330. Specifically, first panel 328 is received by first crescent recess 308 and secured (e.g., via friction and/or pressure) by first inner wall 312, first tip section 320, and third tip section 326. Second panel 330 is received by second crescent recess 310 and secured (e.g., via friction and/or pressure) by third inner wall 316, second tip section 322, and fourth tip section 328. Each of first crescent recess 308 and second crescent recess 310 may be triangular with an opening that is narrower than a base near an inner wall. As depicted in FIG. 3A, linear sealing component 300 couples first panel 328 and second panel 330 via elastic deformation such as compression of the third volume 306 substantially along the reference center line. The open core design may improve compressibility of the third volume 306 such that linear sealing component 300 may be fitted into smaller panel gaps, such as the ⅛ inch gap shown in FIG. 3A. However, the closed core design on FIG. 2A may have superior sound dampening performance.

FIG. 3B shows linear sealing component 300 of FIG. 3A being fitted into a panel gap of greater distance than in FIG. 3A. Specifically, the panel gap of FIG. 3B is ½ inch and is between a third panel 336 and a fourth panel 338. Third panel 336 is received by first crescent recess 308 and secured (e.g., via friction and/or pressure) by first inner wall 312, first tip section 320, and third tip section 326. Fourth panel 338 is received by second crescent recess 310 and secured (e.g., via friction and/or pressure) by third inner wall 316, second tip section 322, and fourth tip section 328. Each of first crescent recess 308 and second crescent recess 310 may be triangular with an opening that is narrower than a base near an inner wall. As depicted in FIG. 3A, linear sealing component 300 couples first panel 328 and second panel 330 via elastic deformation such as compression of the third volume 306 slightly along the reference center line. A smaller degree of third volume 306 compression is needed because the panel gap in FIG. 3B is larger than that of FIG. 3A. As shown, third panel 336 and fourth panel 338 are three times thicker than first panel 328 and second panel 330 in FIG. 3A such as ⅜ inch rather than ⅛ inch. Linear sealing component 300 is configured to receive panels of larger range of thicknesses (e.g., 1/16 inch to ½ inch) at least because internal walls 312 and 316 are of greater length. In certain scenarios, linear sealing component 300 may receive and secure panels of thicknesses from 1-3 times its recess opening size.

### Co-Reactive Compositions

Reactant mixtures for fabricating linear sealing components of the present disclosure can comprise prepolymers having any suitable backbone, prepolymers having any suitable reactive functional groups, coreactive compounds based on any suitable curing chemistry, and any suitable additives. A reactant mixture may be a co-reactive composition comprising a first compound having a first functional group and a second compound comprising a second functional group where the first functional group is reactive with the second functional group. The first and second compound can independently comprise a monomer, a combination of monomers, a prepolymer, a combination of prepolymers, or a combination thereof.

A coreactive composition can comprise a one-part coreactive composition in which the reaction between the coreactive compounds is initiated by exposure to energy such as by exposure to actinic radiation (e.g., ultraviolet radiation).

A coreactive composition can comprise coreactive compounds capable of reacting at a temperature less than 50° C., such as less than 40° C., less than 30° C., less than 20° C., or less than 10° C. without exposure to actinic radiation or following exposure to actinic radiation.

For instance, the coreactive compounds can react at a temperature from 5° C. to 50° C., from 10 C to 40° C., or from 15° C. to 25° C., or from 20° C. to 30° C.

A coreactive composition have a viscosity at 25° C. and a shear rate at 0.1 sec⁻¹ to 100 sec⁻¹, such as from 200 cP to 50,000,000 cP, from 200 cP to 20,000,000 cP, from 1,000 cP to 18,000,000 cP, from 5,000 cP to 15,000,000 cP, from 5,000 cP to 10,000,000 cP, from 5,000 cP to 5,000,000 cP, from 5,000 cP to 1,000,000 cP, from 5,000 cP to 100,000 cP, from 5,000 cP to 50,000 cP, from 5,000 cP to 20,000 cP, from 6,000 cP to 15,000 cP, from 7,000 cP to 13,000 cP, or from 8,000 cP to 12,000 cP. A coreactive composition have a viscosity at 25° C. and a shear rate at 0.1 sec⁻¹ to 100 sec⁻¹ such as greater than 200 cP, greater than 1,000 cP, greater than 10,000 cP, greater than 100,000 cP, greater than 1,000,000 cP, or greater than 10,000,000 cP. A coreactive composition have a viscosity at 25° C. and a shear rate at 0.1 sec⁻¹ to 100 sec⁻¹ such as less than 100,000,000 cP, less than 10,000,000 cP, less than 1,000,000 cP, less than 100,000 cP, less than 10,000 cP, or less than 1,000 cP. Viscosity values are measured using an Anton Paar MCR 302 rheometer with a gap from 1 mm at a temperature of 25° C. and a shear rate of 100 sec⁻¹.

A coreactive composition can be formulated as a sealant composition that forms a linear sealing component upon cure.

A linear sealing component refers to a material that has the ability to resist atmospheric conditions, such as noise, moisture, and temperature and/or at least partially block the transmission of materials, such as water, solvent, fuel, hydraulic fluid and other liquids and gasses. A linear sealing component can exhibit chemical resistance such as resistance to fuels and hydraulic fluids. A chemically resistant material can exhibit a % swell less than 25%, less than 20%, less than 15%, or less than 10% following immersion in the chemical for 7 days at 70° C. as determined according to EN ISO 10563. A sealant can exhibit resistance to Jet Reference Fluid (JRF) Type I, or to Skydrol® LD-40 hydraulic fluid. For instance, a linear sealing component of the present disclosure may exhibit chemical resistance similar to the sealants described in U.S. Pat. No. 10,047,259, which is hereby incorporated by reference in its entirety for all purposes.

### Prepolymers and Monomers

A prepolymer can have a number average molecular weight such as less than 20,000 Da, less than 15,000 Da, less than 10,000 Da, less than 8,000 Da, less than 6,000 Da, less than 4,000 Da, or less than 2,000 Da. A prepolymer can have a number average molecular weight such as greater than 2,000 Da, greater than 4,000 Da, greater than 6,000 Da, greater than 8,000 Da, greater than 10,000 Da, or greater than 15,000 Da. A prepolymer can have a number average molecular weight such as from 1,000 Da to 20,000 Da, from 2,000 Da to 10,000 Da, from 3,000 Da to 9,000 Da, from 4,000 Da to 8,000 Da, or from 5,000 Da to 7,000 Da.

Prepolymers can be liquid at 25° C. and can have a glass transition temperature Tg, such as, less than −20° C., less than −30° C., or less than −40° C. Prepolymers can exhibit a viscosity such as within a range from 20 poise to 500 poise (2 Pa-sec to 50 Pa-sec), from 20 poise to 200 poise (2 Pa-sec to 20 Pa-sec) or from 40 poise to 120 poise (4 Pa-sec to 12 Pa-see)

### Prepolymer Backbone

A coreactive composition can comprise a prepolymer having any suitable polymeric backbone. A polymeric backbone can be selected, to impart solvent resistance to the cured coreactive composition, to impart desired physical properties such as tensile strength, % elongation, Youngs modulus, impact resistance, or other application-relevant property. A prepolymer backbone can be terminated in one or more suitable functional groups as appropriate for a particular curing chemistry.

A prepolymer backbone can comprise a polythioether, a polysulfide, a polyformal, a polyisocyanate, a polyurea, polycarbonate, polyphenylene sulfide, polyethylene oxide, polystyrene, acrylonitrile-butadiene-styrene, polycarbonate, styrene acrylonitrile, poly(methylmethacrylate), polyvinylchloride, polybutadiene, polybutylene terephthalate, poly(p-phenyleneoxide), polysulfone, polyethersulfone, polyethylenimine, polyphenylsulfone, acrylonitrile styrene acrylate, polyethylene, syndiotactic or isotactic polypropylene, polylactic acid, polyamide, ethyl-vinyl acetate homopolymer or copolymer, polyurethane, copolymers of ethylene, copolymers of propylene, impact copolymers of propylene, polyetheretherketone, polyoxymethylene, syndiotactic polystyrene (SPS), polyphenylene sulfide (PPS), liquid crystalline polymer (LCP), homo- and copolymer of butene, homo- and copolymers of hexene; and combinations of any of the foregoing.

Other suitable prepolymer backbones can include polyolefins (such as polyethylene, linear low density polyethylene (LLDPE), low density polyethylene (LDPE), high density polyethylene, polypropylene, and olefin copolymers), styrene/butadiene rubbers (SBR), styrene/ethylene/butadiene/styrene copolymers (SEBS), butyl rubbers, ethylene/propylene copolymers (EPR), ethylene/propyleneddiene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral), poly(methyl methacrylate) and other acrylate polymers and copolymers (including such as methyl methacrylate polymers, methacrylate copolymers, polymers derived from one or more acrylates, methacrylates, ethyl acrylates, ethyl methacrylates, butyl acrylates, butyl methacrylates and the like), olefin and styrene copolymers, acrylonitrile/butadienedstyrene (ABS), styrene/acrylonitrile polymers (SAN), styrene/maleic anhydride copolymers, isobutylene/maleic anhydride copolymers, ethylenedacrylic acid copolymers, poly(acrylonitrile), polycarbonates (PC), polyamides, polyesters, liquid crystalline polymers (LCPs), poly(lactic acid), poly(phenylene oxide) (PPO), PPO-polyamide alloys, polysulfone (PSU), polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), and poly(vinyl chloride), polyurethanes (thermoplastic and thermosetting), aramides (such as Kevlar® and Nomex®), polytetrafluoroethylene (PTFE), polysiloxanes (including polydimethylenesiloxane, dimethylsiloxane/vinylmethylsiloxane copolymers, vinyldimethylsiloxane terminated poly(dimethylsiloxane)), elastomers, epoxy polymers, polyureas, alkyds, cellulosic polymers (such as ethyl cellulose, ethyl hydroxyethyl cellulose, carboxymethyl cellulose, cellulose acetate, cellulose acetate propionates, and cellulose acetate butyrates), polyethers and glycols such as poly(ethylene oxide)s (also known as poly(ethylene glycol)s, poly(propylene oxide)s (also known as poly(propylene glycol)s, and ethylene oxide/propylene oxide copolymers, acrylic latex polymers, polyester acrylate oligomers and polymers, polyester diol diacrylate polymers, and UV-curable resins.

A coreactive composition can comprise a prepolymer comprising an elastomeric backbone.

An elastomer refers to a material with “rubber-like” property and generally having a low Young's modulus and a high tensile strain. Elastomers can have a tensile strain (elongation at break) from 100% to 2,000%. Elastomers can exhibit a tear strength such as from 50 kN/m to 200 kN/m as determined according to ASTM D624. The Young's modulus of an elastomer can range such as from 0.5 MPa to 30 MPa, such as from 1 MPa to 6 MPa as determined according to ASTM D412.4893.

Suitable prepolymers having an elastomeric backbone may include polyethers, polybutadienes, fluoroelastomers, perfluoroelastomers, ethylene/acrylic copolymers, ethylene propylene diene terpolymers, nitriles, polythiolamines, polysiloxanes, chlorosulfonated polyethylene rubbers, isoprenes, neoprenes, polysulfides, polythioethers, silicones, styrene butadienes, and combinations of any of the foregoing. An elastomeric prepolymer can comprise a polysiloxane such as a polymethylhydrosiloxane, polydimethylsiloxane, polyhydrodiethylsiloxane, polydiethylsiloxane, or a combination of any of the foregoing. The elastomeric prepolymer can comprise terminal functional groups that have a low reactivity with amine and isocyanate groups such as silanol groups.

### Sulfur-Containing Prepolymers

A coreactive composition can comprise a sulfur-containing prepolymer or combination of sulfur-containing prepolymers. Sulfur-containing prepolymers can impart sound resistance to a cured linear sealing component. A sulfur-containing prepolymer can comprise a sulfur-containing prepolymer, a polysulfide prepolymer, a sulfur-containing polyformal prepolymer, a monosulfide prepolymer, or a combination of any of the foregoing.

A “sulfur-containing prepolymer” refers to a prepolymer that has one or more thioether —Sₙ— groups, where n can be 1 to 6 in the backbone of the prepolymer. Prepolymers that contain only thiol or other sulfur-containing groups either as terminal groups or as pendent groups of the prepolymer are not encompassed by sulfur-containing prepolymers. The prepolymer backbone refers to the portion of the prepolymer having repeating segments. Thus, a prepolymer having the structure of HS—R—R(—CH₂—SH)—[—R—(CH₂)₂—S(O)₂—(CH₂)—S(O)₂]ₙ—CH═CH₂ where each R is a moiety that does not contain a sulfur atom, is not encompassed by a sulfur-containing prepolymer. A prepolymer having the structure HS—R—R(—CH₂—SH)—[—R—(CH₂)₂—S(O)₂—(CH₂)—S(O)₂]—CH═CH₂ where at least one R is a moiety that contains a sulfur atom, such as a thioether group, is encompassed by a sulfur-containing prepolymer.

Sulfur-containing prepolymers having a high sulfur content can impart chemical resistance to a cured coreactive composition. A sulfur-containing prepolymer backbone can have a sulfur content greater than 10 wt %, greater than 12 wt %, greater than 15 wt %, greater than 18 wt %, greater than 20 wt %, or greater than 25 wt %, where wt % is based on the total weight of the prepolymer backbone. A chemically resistant prepolymer backbone can have a sulfur content such as from 10 wt % to 25 wt %, from 12 wt % to 23 wt %, from 13 wt % to 20 wt %, or from 14 wt % to 18 wt %, where wt % is based on the total weight of the prepolymer backbone.

Prepolymers having a sulfur-containing backbone may include polythioether prepolymers, polysulfide prepolymers, sulfur-containing polyformal prepolymers, monosulfide prepolymers, and a combination of any of the foregoing.

Coreactive compositions can comprise from 40 wt % to 80 wt %, from 40 wt % to 75 wt %, from 45 wt % to 70 wt %, or from 50 wt % to 70 wt % of a sulfur-containing prepolymer or combination of sulfur-containing prepolymers, where wt % is based on the total weight of the coreactive composition. A coreactive composition can comprise greater than 40 wt %, greater than 50 wt %, greater than 60 wt %, greater than 70 wt %, greater than 80 wt %, or greater than 90 wt % of a sulfur-containing prepolymer or combination of sulfur-containing prepolymer, where wt % is based on the total weight of the coreactive composition. A coreactive composition can comprise less than 90 wt %, less than 80 wt %, less than 70 wt %, less than 60 wt %, less than 50 wt %, or less than 40 wt % of a sulfur-containing prepolymer or combination of sulfur-containing prepolymers, where wt % is based on the total weight of the coreactive composition.

### Coreactive Functional Groups

A coreactive composition can comprise coreactive compounds having any suitable coreactive functional groups.

A first co-reactive compound can comprise one or more first functional groups and the second co-reactive compound can comprise one or more second functional groups, where the one or more first functional groups are reactive with the one or more second functional groups.

A functional group or combination of functional groups can be selected to achieve a desired curing rate.

A first functional group can comprise a thiol group, and a second functional group can comprise a thiol group, an alkenyl group, an alkynyl group, an epoxy group, a Michael acceptor group, an isocyanate group, or a combination of any of the foregoing.

A first functional group can comprise an isocyanate and a second functional group can comprise a hydroxyl group, an amine group, a thiol group, or a combination of any of the foregoing.

A first functional group can comprise an epoxy group and a second functional group can comprise an epoxy group.

A first functional group can comprise, a Michael acceptor group and a second functional group can comprise a Michael donor group.

A first functional group can comprise a carboxylic acid group and the second functional group can comprise an epoxy group.

A first functional group can comprise a cyclic carbonate group, an acetoacetate group, or an epoxy group; and the second functional group can comprise a primary amine group, or a secondary amine group.

A first functional group can comprise a Michael acceptor group such as (meth)acrylate group, a cyanoacrylate, a vinylether a vinylpyridine, or an α,β-unsaturated carbonyl group and the second functional group can comprise a malonate group, an acetylacetonate, a nitroalkane, or another active alkenyl group.

A first functional group can comprise an amine and a second functional group can comprise selected from an epoxy group, an isocyanate group, an acrylonitrile, a carboxylic acid including esters and anhydrides, an aldehyde, or a ketone.

Suitable coreactive functional groups are described in Noomen, Proceedings of the XIIIth International Conference in Organic Coatings Science and Technology, Athens, 1987, page 251; and in Tillet et al., Progress in Polymer Science, 36 (2011), 191-217.

Functional groups can be selected to coreact at temperatures less than 50° C., less than 40° C., less than 30° C., less than 20° C., or less than 10° C. Functional groups can be selected to coreact at temperatures greater than 5° C., greater than 10° C., greater than 20° C., greater than 30° C., or greater than 40° C. Functional groups can be selected to coreact at temperatures from 5° C. to 50° C., from 10° C. to 40° C., from 15° C., to 35° C., or from 20° C. to 30° C.

The cure rate for any of these coreactive chemistries can be modified by including an appropriate catalyst or combination of catalysts in a coreactive composition. The cure rate for any of these coreactive chemistries can be modified by increasing or decreasing the temperature of the coreactive composition. Although a coreactive composition can cure at temperatures less than 30° C., heating the coreactive composition can accelerate the reaction rate, which can be desirable under certain circumstances such as to accommodate an increased printing speed. Increasing the temperature of the coreactive components and/or the coreactive composition can also serve to adjust the viscosity to facilitate mixing the coreactive components and/or depositing the coreactive composition.

### Curable Coreactive Compositions

A coreactive composition can comprise coreactive compounds capable of coreacting at a temperature less than 50° C. without exposure to actinic radiation and can optionally include a catalyst.

A coreactive composition can comprise compounds such as monomers and/or prepolymers comprise coreactive functional groups including any of those disclosed herein.

A coreactive composition can further include a suitable catalyst or combination of catalysts for catalyzing the reaction between the coreactive compounds.

### Radiation-Curable Coreactive Compositions

A coreactive composition can be an actinic radiation-curable coreactive composition in which the curing reaction between the coreactive compounds in the coreactive composition is initiated by exposing the coreactive composition to actinic radiation.

Actinic radiation includes α-rays, γ-rays, X-rays, ultraviolet (UV) radiation (200 nm to 400 nm) such as UV-A radiation (320 nm to 400 nm), UV-B radiation (280 nm to 320 nm), and UV-C radiation (200 nm to 280 nm); visible radiation (400 nm to 770 nm), radiation in the blue wavelength range (450 nm to 490 nm), infrared radiation (>700 nm), near-infrared radiation (0.75 μm to 1.4 μm), and electron beams.

A radiation-curable coreactive composition can comprise compounds capable of coreacting by a free radical mechanism. Free radical curing reactions may include thiol/alkenyl reactions and thiol/alkynyl reactions.

A radiation curable coreactive composition can comprise any suitable free-radical polymerization initiator or combination of suitable free-radical polymerization initiators. free-Radical polymerization initiators may include photoinitiators, thermally activated free radical generators, cationic free radical generators and dark cure free radical generators.

A radiation-curable coreactive composition can comprise a photoinitiator such as a visible photoinitiator or a UV photoinitiator.

A radiation-curable coreactive composition can comprise a thermally activated free radical generator.

A radiation-curable coreactive composition can comprise a cationic free radical generator.

A radiation-curable coreactive composition can comprise a dark cure free radical generator.

The free radical photopolymerization reaction can be initiated by exposing a coreactive composition to actinic radiation such as UV radiation for less than 180 seconds, less than 120 seconds, less than 90 seconds, less than 60 seconds, less than 30 seconds, less than 15 seconds, or less than 5 seconds. The total power of the UV exposure can be from 50 mW/cm² to 500 mW/cm², from 50 mW/cm² to 400 mW/cm², from 50 mW/cm² to 300 mW/cm², from 100 mW/cm² to 300 mW/cm², or from 150 mW/cm² to 250 mW/cm².

An actinic radiation-curable coreactive composition can be exposed to a UV dose of 1 J/cm² to 4 J/cm² to cure the composition. The UV source is an 8 W lamp with a UVA spectrum. Other doses and/or other UV sources can be used. A UV dose for curing a composition can be, from 0.5 J/cm² to 4 J/cm², from 0.5 J/cm² to 3 J/cm², from 1 J/cm² to 2 J/cm², or from 1 J/cm² to 1.5 J/cm².

An actinic radiation-curable coreactive composition can also be cured with radiation at blue wavelength ranges such as using a light-emitting diode.

Actinic radiation-curable sealant compositions suitable for use in linear sealing components are disclosed in U.S. Pat. Nos. 8,729,198; 8,729,198; 9,533,798; 10,233,369; U.S. Application Publication No. 2019/0169465; PCT International Publication No. PCT/US2018/36746; U.S. Application Publication No. 2018/0215974; and U.S. Pat. No. 7,438,974.

### Transmissive Coreactive Compositions

A free radical polymerizable coreactive composition can be transmissive to actinic radiation to an extent that the incident actinic radiation can generate sufficient free radicals to allow the free radical polymerizable coreactive composition to fully cure.

A coreactive composition that is transmissive to actinic radiation can transmit actinic radiation through a thickness of the coreactive composition such as from 1 mm to 30 mm, from 1 mm to 25 mm, from 1 mm to 20 mm, from 1 mm to 15 mm, or from 1 mm to 10 mm.

A free radical polymerizable coreactive composition can be partially transmissive to actinic radiation to an extent that the incident actinic radiation can generate sufficient free radicals to initiate free radical polymerization of the coreactive composition in at least a portion of the exposed coreactive composition. The unexposed portion of the coreactive composition can cure by another free radical mechanism such as a dark cure mechanism or can cure by a non-free radical mechanism.

A free radical-initiating wavelength range can depend on the type of free radical generators in the coreactive composition.

### Curing a Co-Reactive Composition

A coreactive composition capable of curing without exposure to actinic radiation can be deposited and allowed to cure and the rate of cure will be determined by one or more of the curing chemistry, the type and amount of catalyst, the temperature, and the viscosity of the deposited coreactive composition. Following deposition, a coreactive composition can be exposed to heat to accelerate curing of at least a portion of the coreactive composition.

Cure of a free radical polymerizable coreactive composition can be initiated by activating the free radical generator such as by exposing the free-radical polymerizable coreactive composition to actinic radiation or heat.

A free radical polymerizable coreactive composition can be exposed to actinic radiation while the free radical polymerizable coreactive composition is in the three-dimensional printing apparatus, during deposition of the free radical polymerizable coreactive composition, and/or after the free radical polymerizable coreactive composition has been deposited. The deposited free radical polymerizable coreactive composition can be exposed to actinic radiation such as after the coreactive composition is initially deposited or, depending on the method of fabrication, after a linear sealing component is fabricated, or after a linear sealing component is installed between panel gaps.

A linear sealing component can be fabricated by depositing successive layers of an actinic radiation-curable coreactive composition using three-dimensional printing.

To initiate the chemical reaction, the actinic radiation-curable coreactive composition can be exposed to actinic radiation before being extruded from a nozzle, while being extruded from the nozzle, after being extruded from the nozzle, and/or during or after being deposited on a previously deposited layer.

When building the linear sealing component, the physical properties of the coreactive composition can be such that the deposited coreactive composition maintains its intended shape and has sufficient mechanical strength to support overlying layers of the coreactive composition before an underlying layer has fully cured. The physical properties can be determined, in part, by the amounts of the constituents in the composition, by the type and rate of cure and the like.

A linear sealing component can be fabricated by printing coreactive compositions that do not require exposure to actinic radiation to initiate the chemical reaction. The linear sealing component can be fabricated using three-dimensional printing to deposit successive layers of a coreactive composition. Procedures similar to those as described for fabricating an actinic radiation-curable linear sealing component are applicable, with the exception of exposing the coreactive compositions to actinic radiation.

### Photoinitiators

Any suitable photoinitiator such as thermally-activated free radical initiators, or free radical initiators activated by actinic radiation, or photoinitiators and the like.

A photoinitiator can be activated by actinic radiation that can apply energy effective in generating an initiating species from the photopolymerization initiator upon irradiation such as α-rays, γ-rays, X-rays, ultraviolet (UV) light including UVA, UVA, and UVC spectra), visible light, blue light, infrared, near-infrared, or an electron beam. A photoinitiator can be a UV photoinitiator.

Suitable UV photoinitiators may include α-hydroxyketones, benzophenone, α,α-diethoxyacetophenone, 4,4-diethylaminobenzophenone, 2,2-dimethoxy-2-phenylacetophenone, 4-isopropylphenyl 2-hydroxy-2-propyl ketone, 1-hydroxycyclohexyl phenyl ketone, isoamyl p-dimethylaminobenzoate, methyl 4-dimethylaminobenzoate, methyl O-benzoylbenzoate, benzoin, benzoin ethyl ether, benzoin isopropyl ether, benzoin isobutyl ether, 2-hydroxy-2-methyl-1-phenylpropan-1-one, 2-isopropylthioxanthone, dibenzosuberone, 2,4,6-trimethylbenzoyldiphenylphosphine oxide, bisacyclophosphine oxide, benzophenone photoinitiators, oxime photoinitiators, phosphine oxide photoinitiators, and combinations of any of the foregoing.

Thermally activated free radical initiator can become active at elevated temperature, such as at a temperature greater than 25° C.

Suitable thermally activated free radical initiators may include organic peroxy compounds, azobis(organonitrile) compounds, N-acyloxyamine compounds, O-imino-isourea compounds, and combinations of any of the foregoing. Suitable organic peroxy compounds that may be used as thermal polymerization initiators include peroxymonocarbonate esters, such as tertiarybutylperoxy 2-ethylhexyl carbonate and tertiarybutylperoxy isopropyl carbonate; peroxyketals, such as 1,1-di-(tert-butyl peroxy)-3,3,5-trimethylcyclohexane; peroxydicarbonate esters, such as di(2-ethylhexyl)peroxydicarbonate, di(secondary butyl)peroxydicarbonate and diisopropylperoxydicarbonate; diacylperoxides such as 2,4-dichlorobenzoyl peroxide, isobutyryl peroxide, decanoyl peroxide, lauryl peroxide, propionyl peroxide, acetyl peroxide, benzoyl peroxide, and p-chlorobenzoyl peroxide; peroxyesters such as tert-butylperoxy pivalate, tert-butylperoxy octylate, and tert-butylperoxyisobutyrate; methylethylketone peroxide, acetylcyclohexane sulfonyl peroxide, and combinations of any of the foregoing. Other suitable thermal polymerization initiators may include 2,5-dimethyl-2,5-di(2-ethylhexanoylperoxy)hexane, and/or 1,1-bis(tert-butylperoxy)-3,3,5-trimethylcyclohexane. Suitable azobis(organonitrile) compounds that may be used as thermal polymerization initiators include azobis(isobutyronitrile), 2,2′-azobis(2-methyl-butanenitrile), and/or azobis(2/1-dimethylvaleronitrile).

A coreactive composition can also be cured by means other than by using actinic radiation such as coreactive compounds as noted above will typically comprise two or more corrective compounds

For use in three-dimensional printing, a first coreactive component and the second coreactive component can be combined in a mixer to form a coreactive composition that can be extruded from a nozzle and deposited to form a linear sealing component. With time after deposition, the coreactive composition cures to provide a cured linear sealing component.

The use of coreactive three-dimensional printing can extend the range of chemistries and compositions used to fabricate linear sealing components beyond those suitable for use in actinic radiation-curable compositions.

Furthermore, although a single coreactive composition can be used to fabricate the linear sealing component, more than one coreactive composition can be used, where each coreactive composition is tailored to optimize a desired property. A coreactive composition applied directly to the fastener can be configured to facilitate adhesion to the fastener surface and to be low-density, and an outer coreactive composition that is applied over the inner coreactive composition can be configured to provide enhanced fuel resistance.

The chemistries of the inner and outer coreactive compositions can be the same or can be different. Using the same curing chemistries for the inner and outer coreactive compositions can facilitate adhesion between the two coreactive compositions by the formation of covalent bonds.

Coreactive curing chemistries may include thiol/alkenyl, thiol/alkynyl, thiol/thiol, thiol/Michael acceptor, thiol/epoxy, thiol/isocyanate, isocyanate/hydroxyl, isocyanate/amine, and Michael donor/Michael acceptor.

### Polyioether

A coreactive composition can comprise a polythioether prepolymer or a combination of polythioether prepolymers.

A polythioether prepolymer can comprise a polythioether prepolymer comprising at least one moiety having the structure of Formula (2), a thiol-terminated polythioether prepolymer of Formula (2a), a terminal-modified polythioether of Formula (2b), or a combination of any of the foregoing:

—S—R¹—[S-A-S—R¹-]ₙ-S— (2)

HS—R¹—[S-A-S—R¹-]ₙ-SH (2a)

R³—S—R¹—[S-A-S—R¹-]ₙ-S—R³ (2b)
wherein,
   n can be an integer from 1 to 60;
each R¹ can independently be selected from C₂₋₁₀ alkanediyl, C₆₋₈ cycloalkanediyl, C₆₋₁₄ alkanecycloalkanediyl, C₅₋₈ heterocycloalkanediyl, and —[(CHR)ₚ—X—]_{q}(CHR)ᵣ—, where,
p can be an integer from 2 to 6;
q can be an integer from 1 to 5;
r can be an integer from 2 to 10;
each R can independently be selected from hydrogen and methyl; and
each X can independently be selected from O, S, and S—S; and
each A can independently be a moiety derived from a polyvinyl ether of Formula (3) and a polyalkenyl polyfunctionalizing agent of Formula (4):

CH₂=CH—O—(R²—O)ₘ—CH═CH₂ (3)

B(—R⁴—CH═CH₂)_{z} (4)
wherein,
   m can be an integer from 0 to 50;
each R² can independently be selected from C₁₋₁₀ alkanediyl, C₆₋₈ cycloalkanediyl, C₆₋₁₄ alkanecycloalkanediyl, and —[(CHR)ₚ—X—]_{q}(CHR)ᵣ—, wherein p, q, r, R, and X are as defined as for R¹;
each R³ can independently be moiety comprising a terminal reactive group;
B represents a core of a z-valent, polyalkenyl polyfunctionalizing agent B(—R⁷—CH═CH₂)_{z}
wherein,
z can be an integer from 3 to 6; and
each R⁴ can independently be selected from C₁₋₁₀ alkanediyl, C₁₋₁₀ heteroalkanediyl, substituted C₁₋₁₀ alkanediyl, and substituted C₁₋₁₀ heteroalkanediyl.

In moieties of Formula (2) and prepolymers of Formula (2a) and (2b), R¹ can be C₂₋₁₀ alkanediyl.

In moieties of Formula (2) and prepolymers of Formula (2a) and (2b), R¹ can be —[(CHR)ₚ—X—]_{q}(CHR)ᵣ—.

In moieties of Formula (2) and prepolymers of Formula (2a) and (2b), X can be selected from O and S, and thus —[(CHR)ₚ—X—]_{q}(CHR)ᵣ— can be —[(CHR)ₚ—O—]_{q}(CHR)ᵣ— or —[(CHR)ₚ—S—]_{q}(CHR)ᵣ—. P and r can be equal, such as where p and r can both be two.

In moieties of Formula (2) and prepolymers of Formula (2a) and (2b), R¹ can be selected from C₂₋₆ alkanediyl and —[(CHR)ₚ—X—]_{q}(CHR)ᵣ—.

In moieties of Formula (2) and prepolymers of Formula (2a) and (2b), R¹ can be —[(CHR)ₚ—X—]_{q}(CHR)ᵣ—, and X can be O, or X can be S.

In moieties of Formula (2) and prepolymers of Formula (2a) and (2b), where R¹ can be —[(CHR)ₚ—X—](CHR)ᵣ, p can be 2, r can be 2, q can be 1, and X can be S; or p can be 2, q can be 2, r can be 2, and X can be O; or p can be 2, r can be 2, q can be 1, and X can be O.

In moieties of Formula (2) and prepolymers of Formula (2a) and (2b), R¹ can be —[(CHR)ₚ—X—]_{q}(CHR)ᵣ—, each R can be hydrogen, or at least one R can be methyl.

In moieties of Formula (2) and prepolymers of Formula (2a) and (2b), R¹ can be —[(CH₂)ₚ—X—]_{q}(CH₂)ᵣ— wherein each X can independently be selected from O and S.

In moieties of Formula (2) and prepolymers of Formula (2a) and (2b), R¹ can be —[(CH₂)ₚ—X—]_{q}(CH₂)ᵣ— each X can be O or each X can be S.

In moieties of Formula 2) and prepolymers of Formula (2a) and (2b), R¹ can be —[(CH₂)ₚ—X—]_{q}(CH₂)ᵣ, where p can be 2, X can be O, q can be 2, r can be 2, R² can be ethanediyl, m can be 2, and n can be 9.

In moieties of Formula (2) and prepolymers of Formula (2a) and (2b), each R¹ can be derived from 1,8-dimercapto-3,6-dioxaoctane (DMDO; 2,2-(ethane-1,2-diylbis(sulfanyl))bis(ethan-1-thiol)), or each R¹ can be derived from dimercaptodiethylsulfide (DMDS; 2,2′-thiobis(ethan-1-thiol)), and combinations thereof.

In moieties of Formula (2) and prepolymers of Formula (2a) and (2b), each p can independently be selected from 2, 3, 4, 5, and 6. Each p can be the same and can be 2, 3, 4, 5, or 6.

In moieties of Formula (2) and prepolymers of Formula (2a) and (2b), each q can independently be 1, 2, 3, 4, or 5. Each q can be the same and can be 1, 2, 3, 4, or 5.

In moieties of Formula (2) and prepolymers of Formula (2a) and (2b), each r can independently be 2, 3, 4, 5, 6, 7, 8, 9, or 10. Each r can be the same and can be 2, 3, 4, 5, 6, 7, 8, 9, or 10.

In moieties of Formula (2) and prepolymers of Formula (2a) and (2b), each r can independently be an integer from 2 to 4, from 2 to 6, or from 2 to 8.

In divinyl ethers of Formula (3), m can be an integer from 0 to 50, such as from 0 to 40, from 0 to 20, from 0 to 10, from 1 to 50, from 1 to 40, from 1 to 20, from 1 to 10, from 2 to 50, from 2 to 40, from 2 to 20, or from 2 to 10.

In divinyl ethers of Formula (3), each R² can independently be selected from a C₂₋₁₀ n-alkanediyl group, a C₃₋₆ branched alkanediyl group, and a —[(CH₂)ₚ—X—]_{q}(CH₂)ᵣ— group.

In divinyl ethers of Formula (3), each R² can independently be a C₂₋₁₀ n-alkanediyl group, such as methanediyl, ethanediyl, n-propanediyl, or n-butanediyl.

In divinyl ethers of Formula (3), each R² can independently comprise a —[(CH₂)ₚ—X-]_{q}(CH₂)ᵣ— group, where each X can be O or S.

In divinyl ethers of Formula (3), each R² can independently comprise a —[(CH₂)ₚ—X-]_{q}(CH₂)ᵣ— group.

In divinyl ethers of Formula (3), each m can be independently an integer from 1 to 3.

Each m can be the same and can be 1, 2, or 3.

In divinyl ethers of Formula (3), each R² can independently be selected from a C₂-1o n-alkanediyl group, a C₃-6 branched alkanediyl group, and a —[(CH₂)ₚ—X—]_{q}(CH₂)ᵣ— group.

In divinyl ethers of Formula (3), each R² can independently be a C₂₋₁₀ n-alkanediyl group.

In divinyl ethers of Formula (3), each R² can independently be a —[(CH₂)ₚ—X-]_{q}(CH₂)ᵣ— group, where each X can be O or S.

In divinyl ethers of Formula (3), each R² can independently be a —[(CH₂)ₚ—X-]_{q}(CH₂)ᵣ— group, where each X can be O or S, and each p can independently be 2, 3, 4, 5, and 6.

In divinyl ethers of Formula (3), each p can be the same and can be 2, 3, 4, 5, or 6.

In divinyl ethers of Formula (3), each R² can independently be a —[(CH₂)ₚ—X-]_{q}(CH₂)ᵣ— group, where each X can be 0 or S, and each q can independently be 1, 2, 3, 4, or 5.

In divinyl ethers of Formula (3), each q can be the same and can be 1, 2, 3, 4, or 5.

In divinyl ethers of Formula (3), each R² can independently be a —[(CH₂)ₚ—X-]_{q}(CH₂)ᵣ— group, where each X can be 0 or S, and each r can independently be 2, 3, 4, 5, 6, 7, 8, 9, or 10.

In divinyl ethers of Formula (3), each r can be the same and can be 2, 3, 4, 5, 6, 7, 8, 9, or 10. In divinyl ethers of Formula (3), each r can independently be an integer from 2 to 4, from 2 to 6, or from 2 to 8.

Suitable divinyl ethers may include ethylene glycol divinyl ether (EG-DVE butanediol divinyl ether (BD-DVE) hexanediol divinyl ether (HD-DVE), diethylene glycol divinyl ether (DEG-DVE), triethylene glycol divinyl ether, tetraethylene glycol divinyl ether, polytetrahydrofuryl divinyl ether, cyclohexane dimethanol divinyl ether, and combinations of any of the foregoing.

A divinyl ether can comprise a sulfur-containing divinyl ether. Suitable sulfur-containing divinyl ethers are disclosed in PCT Publication No. WO 2018/085650.

In moieties of Formula (3) each A can independently be derived from a polyalkenyl polyfunctionalizing agent. A polyalkenyl polyfunctionalizing agent can have the structure of Formula (4), where z can be 3, 4, 5, or 6.

In polyalkenyl polyfunctionalizing agents of Formula (4), each R⁷ can independently be selected from C₁₋₁₀ alkanediyl, C₁₋₁₀ heteroalkanediyl, substituted C₁₋₁₀ alkanediyl, or substituted C₁₋₁₀ heteroalkanediyl. The one or more substituent groups can be selected from —OH, ═O, C₁₋₄ alkyl, and C₁4 alkoxy. The one or more heteroatoms can be selected from O, S, and a combination thereof.

Suitable polyalkenyl polyfunctionalizing agents can include triallyl cyanurate (TAC), triallylisocyanurate (TAIC), 1,3,5-triallyl-1,3,5-triazinane-2,4,6-trione), 1,3,5-triallyl-1,3,5-triazinane-2,4,6-trione), 1,3-bis(2-methylallyl)-6-methylene-5-(2-oxopropyl)-1,3,5-triazinone-2,4-dione, tris(allyloxy)methane, pentaerythritol triallyl ether, 1-(allyloxy)-2,2-bis((allyloxy)methyl)butane, 2-prop-2-ethoxy-1,3,5-tris(prop-2-enyl)benzene, 1,3,5-tris(prop-2-enyl)-1,3,5-triazinane-2,4-dione, and 1,3,5-tris(2-methylallyl)-1,3,5-triazinane-2,4,6-trione, 1,2,4-trivinylcyclohexane, trimethylolpropane trivinyl ether, and combinations of any of the foregoing.

In moieties of Formula (2) and prepolymers of Formula (2a)-(2b), the molar ratio of moieties derived from a divinyl ether to moieties derived from a polyalkenyl polyfunctionalizing agent can be from 0.9 mol % to 0.999 mol %, from 0.95 mol % to 0.99 mol %, or from 0.96 mol % to 0.99 mol %.

In moieties of Formula (2) and prepolymers of Formula (2a)-(2b), each R¹ can be —(CH₂)₂—O—(CH₂)₂—O—(CH₂)₂—; each R² can be —(CH₂)₂—; and m can be an integer from 1 to 4.

In moieties of Formula (2) and prepolymers of Formula (2a)-(2b), R² can be derived from a divinyl ether such a diethylene glycol divinyl ether, a polyalkenyl polyfunctionalizing agent such as triallyl cyanurate, or a combination thereof.

In moieties of Formula (2) and prepolymers of Formula (2a)-(2b), each A can independently be selected from a moiety of Formula (3a) and a moiety of Formula (4a):

—(CH₂)₂—O—(R²—O)ₘ—(CH₂)₂— (3a)

B{—R⁴—(CH₂)₂—}₂{—R⁴—(CH₂)₂—S—[—R¹—S-A-S—R¹-]ₙ—SH}_{z-2} (4a)

where m, R¹, R², R⁴, A, B, m, n, and z are defined as in Formula (2), Formula (3), and Formula (4).

In moieties of Formula (3) and prepolymers of Formula (2a)-(2b), each R¹ can be —(CH₂)₂—O—(CH₂)₂—O—(CH₂)₂—; each R² can be —(CH₂)₂—; m can be an integer from 1 to 4; and the polyfunctionalizing agent B(—R—CH═CH₂)_{Z} comprises triallyl cyanurate where z is 3 and each R⁴ is —O—CH₂—CH═CH₂.

Methods of synthesizing sulfur-containing polythioethers are disclosed in U.S. Pat. No. 6,172,179.

The backbone of a thiol-terminated polythioether prepolymer can be modified to improve the properties such as adhesion, tensile strength, elongation, UV resistance, hardness, and/or flexibility of sealants and coatings prepared using polythioether prepolymers. Adhesion promoting groups, antioxidants, metal ligands, and/or urethane linkages can be incorporated into the backbone of a polythioether prepolymer to improve one or more performance attributes. Backbone-modified polythioether prepolymers are disclosed in any one of U.S. Pat. No. 8,138,273 (urethane containing), U.S. Pat. No. 9,540,540 (sulfone-containing), U.S. Pat. No. 8,952,124 (bis(sulfonyl)alkanol-containing), U.S. Pat. No. 9,382,642 (metal-ligand containing), U.S. Application Publication No. 2017/0114208 (antioxidant-containing), PCT International Publication No. WO 2018/085650 (sulfur-containing divinyl ether), and PCT International Publication No. WO 2018/031532 (urethane-containing). Polythioether prepolymers include prepolymers described in U.S. Application Publication Nos. 2017/0369737 and 2016/0090507.

Suitable thiol-terminated polythioether prepolymers are disclosed in U.S. Pat. No. 6,172,179. A thiol-terminated polythioether prepolymer can comprise Permapol® P3.1E, Permapol® P3.1E-2.8, Permapol® L56086, or a combination of any of the foregoing, each of which is available from PPG Aerospace. These Permapol® products are encompassed by the thiol-terminated polythioether prepolymers of Formula (2), (2a), and (2b). Thiol-terminated polythioethers include prepolymers described in U.S. Pat. No. 7,390,859 and urethane-containing polythiols described in U.S. Application Publication Nos. 2017/0369757 and 2016/0090507.

### Polysulfides

A sulfur-containing prepolymer can comprise a polysulfide prepolymer or a combination of polysulfide prepolymers.

A polysulfide prepolymer refers to a prepolymer that contains one or more polysulfide linkages, i.e., —Sₓ— linkages, where x is from 2 to 4, in the prepolymer backbone. A polysulfide prepolymer can have two or more sulfur-sulfur linkages. Suitable thiol-terminated polysulfide prepolymers are commercially available from AkzoNobel and Toray Industries, Inc. under the tradenames Thioplast® and from Thiokol-LP®, respectively.

Suitable polysulfide prepolymers are disclosed in U.S. Pat. Nos. 4,623,711; 6,172,179; 6,509,418; 7,009,032; and 7,879,955.

Suitable thiol-terminated polysulfide prepolymers can include Thioplast® G polysulfides such as Thioplast® G1, Thioplast® G4, Thioplast® G10, Thioplast® G12, Thioplast® G21, Thioplast® G22, Thioplast® G44, Thioplast® G122, and Thioplast® G131, which are commercially available from AkzoNobel. Thioplast® G resins are liquid thiol-terminated polysulfide prepolymers that are blends of di- and tri-functional molecules where the difunctional thiol-terminated polysulfide prepolymers have the structure of Formula (5) and the trifunctional thiol-terminated polysulfide polymers can have the structure of Formula (6):

HS—(—R⁵—S—S—)_{d}—R⁵—SH (5)

HS—(—R⁵—S—S—)ₐ—CH₂—CH{—CH₂—(—S—S—R⁵—)_{b}—SH}{—(—S—S—R⁵—)_{c}—SH} (6)

where each R⁵ is —(CH₂)₂—O—CH₂—O—(CH₂)₂—, and d=a+b+c, where the value for d may be from 7 to 38 depending on the amount of the trifunctional cross-linking agent (1,2,3-trichloropropane; TCP) used during synthesis of the polysulfide prepolymer. Thioplast® G polysulfides can have a number average molecular weight from less than 1,000 Da to 6,500 Da, an SH content from 1% to greater than 5.5%, and a cross-linking density from 0% to 2.0%.

Polysulfide prepolymers can further comprise a terminal-modified polysulfide prepolymer having the structure of Formula (5a), a terminal modified polysulfide prepolymer having the structure of Formula (6a), or a combination thereof:

R³—S—(—R⁵—S—S—)_{d}—R⁵—S—R³ (5a)

R³—S—(—R⁵—S—S—)ₐ—CH₂—CH{—CH₂—(—S—S—R⁵—)_{b}-S—}{—(—S—S—R⁵—)_{c}—S—R³} (6a)

where d, a, b, c, and R⁵ are defined as for Formula (6) and Formula (7), and R³ is a moiety comprising a terminal reactive group.

Suitable thiol-terminated polysulfide prepolymers alsocan include Thiokol® LP polysulfides available from Toray Industries, Inc. such as Thiokol® LP2, Thiokol® LP3, Thiokol™ LP12, Thiokol® LP23, Thiokol® LP33, and Thiokol® LP55. Thiokol® LP polysulfides have a number average molecular weight from 1,000 Da to 7,500 Da, a —SH content from 0.8% to 7.7%, and a cross-linking density from 0% to 2%. Thiokol™ LP polysulfide prepolymers have the structure of Formula (7) and terminal-modified polysulfide prepolymers can have the structure of Formula (7a):

HS—[(CH₂)₂O—CH₂—O—(CH₂)₂—S—S-]ₑ—(CH₂)₂—O—CH₂—O—(CH₂)₂—SH (7)

R³—S—[(CH₂)₂O—CH₂—O—(CH₂)₂—S—S—]ₑ—(CH₂)₂O—CH₂—O—(CH₂)₂—S—R³ (7a)

where e can be such that the number average molecular weight from 1,000 Da to 7,500 Da, such as an integer from 8 to 80, and each R⁶ is a moiety comprising a terminal reactive functional group.

A thiol-terminated sulfur-containing prepolymer can comprise a Thiokol-LP® polysulfide, a Thioplast® G polysulfide, or a combination thereof.

A polysulfide prepolymer can comprise a polysulfide prepolymer comprising a moiety of Formula (7), a thiol-terminated polysulfide prepolymer of Formula (7a), a terminal-modified polysulfide prepolymer of Formula (7b), or a combination of any of the foregoing:

—R⁶—(S_{y}—R⁶)ₜ—(7)

HS—R⁶—(S_{y}—R⁶)ᵣ—SH (7a)

R³—S—R⁶—(S_{y}—R⁶)ₜ—S—R³ (7b)
where,
   t can be an integer from 1 to 60;
   y can have an average value within a range from 1.0 to 1.5;
each R can independently be selected from branched alkanediyl, branched arenediyl, and a moiety having the structure —(CH₂)ₚ—O—(CH₂)_{q}—O—(CH₂)ᵣ—, wherein,
   q can be an integer from 1 to 8;
   p can be an integer from 1 to 10; and
r can be an integer from 1 to 10; and
each R³ is a moiety comprising a terminal reactive functional group.

In moieties of Formula (7) and prepolymers of Formula (7a)-(7b), 0% to 20% of the R⁶ groups can comprise branched alkanediyl or branched arenediyl, and 80% to 100% of the R⁶ groups can be —(CH₂)ₚ—O—(CH₂)_{q}—O—(CH₂)ᵣ—.

In moieties of Formula (7) and prepolymers of Formula (7a)-(7b), a branched alkanediyl or a branched arenediyl can be —R(-A)_{f}— where R is a hydrocarbon group, f is 1 or 2, and A is a branching point. A branched alkanediyl can have the structure —CH₂(—CH(—CH₂—)—)—.

Exemplary thiol-terminated polysulfide prepolymers of Formula (7a) and (7b) are disclosed in U.S. Application Publication No. 2016/0152775, in U.S. Pat. No. 9,079,833, and in U.S. Pat. No. 9,663,619.

A sulfur-containing prepolymer can comprise a sulfur-containing polyformal prepolymer or a combination of sulfur-containing polyformal prepolymers. Sulfur-containing polyformal prepolymers useful in sealant applications are disclosed in U.S. Pat. No. 8,729,216 and in U.S. Pat. No. 8,541,513.

A polysulfide prepolymer can comprise a polysulfide prepolymer comprising a moiety of Formula (8), a thiol-terminated polysulfide prepolymer of Formula (8a), a terminal-modified polysulfide prepolymer of Formula (8b), or a combination of any of the foregoing:

—(R⁷—O—CH₂—O—R⁷—Sₛ—)_{g-1}—R⁷—O—CH₂—O—R⁷— (8)

HS—(R⁷—O—CH₂O—R—Sₛ—)_{g-1}—R⁷—O—CH₂O—R⁷—SH (8a)

R³—S—(R⁷—CH—O—R⁷—Sₛ—)_{g-1}—R⁷—O—CH₂—O—R⁷—S—R³ (8b)
where R⁷ is C₂₋₄ alkanediyl, s is an integer from 1 to 8, and g is an integer from 2 to 370; and each R³ is independently a moiety comprising a terminal reactive functional group.

In moieties of Formula (8) and prepolymers of Formula (8a)-(8b), are disclosed in JP 62-53354.

### Sulfur-Containing Polyformals

A sulfur-containing polyformal prepolymer can comprise a moiety of Formula (9), a thiol-terminated sulfur-containing polyformal prepolymer of Formula (9a), a terminal-modified sulfur-containing polyformal prepolymer of Formula (9b), a thiol-terminated sulfur-containing polyformal prepolymer of Formula (9c), a terminal-modified sulfur-containing polyformal prepolymer of Formula (9d), or a combination of any of the foregoing:

—R⁸—(S)ₚ—R⁸—[O—C(R⁹)₂—O—R⁸—(S)ᵥ—R⁸—]ₕ— (9)

R¹⁰—R⁸—(S)ₚ—R⁸—[O—C(R⁹)₂—O—R⁸—(S)ᵥ—R⁸-]ₕ—R¹⁰ (9a)

R³—R⁸—(S)ₚ—R⁸—[O—C(R⁹)₂—O—R⁸—(S)ᵥ—R⁸-]ₕ—R³ (9b)

{R¹⁰—R⁸—(S)ₚ—R⁸—[O—C(R⁹)₂—O—R⁸—(S)ᵥ—R⁸-]ₕ-O—C(R⁹)₂—O-}ₘZ (9c)

{R³—R⁸—(S)ₚ—R⁸—[O—C(R⁹)₂—O—R⁸—(S)ᵥ—R⁸-]ₕ—O—C(R⁹)₂—O—}ₘZ (9d)

where h can be an integer from 1 to 50; each v can independently be selected from 1 and 2; each R⁸ can be C₂₋₆ alkanediyl; and each R⁹ can independently be selected from hydrogen, C₁₋₆ alkyl, C₇₋₁₂ phenylalkyl, substituted C₇₋₁₂ phenylalkyl, C₆₋₁₂ cycloalkylalkyl, substituted C₆₋₁₂ cycloalkylalkyl, C₃₋₁₂cycloalkyl, substituted C₃₋₁₂ cycloalkyl, C₆₋₁₂ aryl, and substituted C₆₋₁₂ aryl; each R¹⁰ is a moiety comprising a terminal thiol group; and each R³ is independently a moiety comprising a terminal reactive functional group other than a thiol group; and Z can be derived from the core of an m-valent parent polyol Z(OH)ₘ.

### Monosulfides

A sulfur-containing prepolymer can comprise a monosulfide prepolymer or a combination of monosulfide prepolymers.

A monosulfide prepolymer can comprise a moiety of Formula (10), a thiol-terminated monosulfide prepolymer of Formula (10a), a thiol-terminated monosulfide prepolymer of Formula (10b), a terminal-modified monosulfide prepolymer of Formula (10c), a terminal-modified monosulfide prepolymer of Formula (10d), or a combination of any of the foregoing:

S—R¹³—[—S—(R¹¹—X)_{w}—(R¹²—X)ᵤ—R¹³—]ₓ—S— (10)

HS—R¹³—[—S—(R¹¹—X)_{w}—(R¹²—X)ᵤ—R¹³—]ₓ—SH (10a)

{HS—R¹³—[—S—(R₁₁—X)_{w}—(R¹²—X)ᵤ—R¹³-]ₓ—S—V′—)}_{z}B (10b)

R³—S—R¹³—[—S—(R¹¹—X)_{w}'(R¹²—X)ᵤ—R¹³—]ₓ—S—R³ (10c)

{R³—S—R¹³—[—S—(R¹¹—X)_{w}—(R¹²—X)ᵤ—R¹³—]ₓ—S—V′—})_{z}B (10d)

wherein,
each R¹¹ can independently be selected from C₂₋₁₀ alkanediyl, such as C₂₋₆ alkanediyl; C₂₋₁₀ branched alkanediyl, such as C₃₋₆ branched alkanediyl or a C₃₋₆ branched alkanediyl having one or more pendant groups which can be alkyl groups, such as methyl or ethyl groups; C₆₋₈ cycloalkanediyl; C₆₋₁₄ alkylcycloalkyanediyl, such as C₆₋₁₀ alkylcycloalkanediyl; and C₈₋₁₀ alkylarenediyl;
each R¹² can independently be selected from hydrogen, C₁₋₁₀ n-alkanediyl, such as C₁₋₆ n-alkanediyl, C₂₋₁₀ branched alkanediyl, such as C₃₋₆ branched alkanediyl having one or more pendant groups which can be alkyl groups, such as methyl or ethyl groups; C₆₋₈ cycloalkanediyl; C₆₋₁₄ alkylcycloalkanediyl, such as C₆₋₁₀ alkylcycloalkanediyl; and C₈₋₁₀ alkylarenediyl;
each R¹³ can independently be selected from hydrogen, C₁₋₁₀ n-alkanediyl, such as C₁₋₆ n-alkanediyl, C₂₋₁₀ branched alkanediyl, such as C₃₋₆ branched alkanediyl having one or more pendant groups which can be alkyl groups, such as methyl or ethyl groups; C₆₋₈ cycloalkanediyl group; C₆₋₁₄ alkylcycloalkanediyl, such as a C₆₋₁₀ alkylcycloalkanediyl; and C₈₋₁₀ alkylarenediyl;
each X can independently be selected from O and S;
w can be an integer from 1 to 5;
u can be an integer from 0 to 5; and
x can be an integer from 1 to 60, such as from 2 to 60, from 3 to 60, or from 25 to 35;
each R³ is independently selected from a reactive functional group;
B represents a core of a z-valent polyfunctionalizing agent B(—V)_{z} wherein:
z can be an integer from 3 to 6; and
each V can be a moiety comprising a terminal group reactive with a thiol group;
each —V′—can be derived from the reaction of —V with a thiol.

Methods of synthesizing thiol-terminated monosulfide comprising moieties of Formula (10) or prepolymers of Formula (10b)-(10c) are disclosed in U.S. Pat. No. 7,875,666.

A monosulfide prepolymer can comprise a moiety of Formula (11), a thiol-terminated monosulfide prepolymer comprising a moiety of Formula (11a), comprise a thiol-terminated monosulfide prepolymer of Formula (11b), a thiol-terminated monosulfide prepolymer of Formula (11c), a thiol-terminated monosulfide prepolymer of Formula (11d), or a combination of any of the foregoing:

-[—S—(R¹⁴—X)_{w}—C(R¹⁵)₂—(X—R¹⁴)_{q}-]ₓ-S— (11)

H—[—S—(R¹⁴—X)_{w}—C(R¹⁵)₂—(X—R¹⁴)ᵤ-]ₓ-SH (11a)

R³—[—S—(R¹⁴—X)_{w}—C(R¹⁵)₂—(X—R¹⁴)ᵤ—]ₓ—S—R³ (11b)

{H—[—S—(R¹⁴—X)_{w}—C(R¹⁵)₂—(X—R¹⁴)ᵤ—]ₓ—S—V′—}_{z}B (11c)

{R³—[—S—(R¹⁴—X)_{w}—C(R¹⁵)₂—(X—R¹⁴)ᵤ—]ₓ—S—V′—}_{z}B (11d)
wherein,
each R¹⁴ can independently be selected from C₂₋₁₀ alkanediyl, such as C₂₋₆ alkanediyl; a C₃₋₁₀ branched alkanediyl, such as a C₃₋₆ branched alkanediyl or a C₃₋₆ branched alkanediyl having one or more pendant groups which can be alkyl groups, such as methyl or ethyl groups; a C₆₋₈ cycloalkanediyl; a C₆₋₁₄ alkylcycloalkyanediyl, such as a C₆₋₁₀ alkylcycloalkanediyl; and a C₈₋₁₀ alkylarenediyl;
each R¹⁵ can independently be selected from hydrogen, C₁₋₁₀ n-alkanediyl, such as a C₁₋₆ n-alkanediyl, C₃₋₁₀ branched alkanediyl, such as a C₃₋₆ branched alkanediyl having one or more pendant groups which can be alkyl groups, such as methyl or ethyl groups; a C₆₋₈ cycloalkanediyl group; a C₆₋₁₄ alkylcycloalkanediyl, such as a C₆₋₁₀ alkylcycloalkanediyl; and a C₈₋₁₀ alkylarenediyl;
each X can independently be selected from O and S;
w can be an integer from 1 to 5;
u can be an integer from 1 to 5;
x can be an integer from 1 to 60, such as from 2 to 60, from 3 to 60, or from 25 to 35;
each R³ is a moiety comprising a terminal functional group;
B represents a core of a z-valent polyfunctionalizing agent B(—V)_{z} wherein:
   z can be an integer from 3 to 6; and
   each V can be a moiety comprising a terminal group reactive with a thiol group;
each —V′—can be derived from the reaction of —V with a thiol.

Methods of synthesizing monosulfides of Formula (11)-(11d) are disclosed in U.S. Pat. No. 8,466,220.

### Co-Reactive Groups

A coreactive composition can have a tack free time a tack free time of less than 8 hours at 25 C/50% RH, less than 6 hours, less than 4 hours, less than 2 hours, less than 1 hour, or less than 30 minutes, where the tack free time is determined according to AS5127/1 (5.8) (Aerospace Standard Test Methods for Aerospace Sealants).

A coreactive composition for forming a linear sealing component that exhibits a fast time to a hardness of Shore 10A can comprise coreactants having a fast cure chemistry, systems curable by actinic radiation, catalysts, and combinations of any of the foregoing.

A cured composition can exhibit a fast time to a hardness of Shore 10A of less than 10 minutes where hardness is determined according to ISO 868 at 23° C./55% RH.

A coreactive composition for forming a linear sealing component that exhibits electrical conductivity, EMI/RFI shielding, and/or static dissipation can comprise electrically conductive filler or a combination of electrically conductive filler.

### Additives

A coreactive composition can comprise one or more additives such as catalysts, polymerization initiators, adhesion promoters, reactive diluents, plasticizers, filler, colorants, photochromic agents, rheology modifiers, reactive diluents cure activators and accelerators, corrosion inhibitors, fire retardants, UV stabilizers, rain erosion inhibitors, or a combination of any of the foregoing.

### Catalyst

A coreactive composition can comprise a catalyst or combination of catalysts, where the one or more catalysts is selected to catalyze the reaction between the coreactants in the coreactive composition such as the first coreactive compound and the second coreactive compound.

A catalyst or combination of catalysts can be selected to catalyze the reaction of co-reactants in the coreactive composition such as the reaction of the first compound and the second. The appropriate catalyst will depend on the curing chemistry such as a thiol-ene or thiol epoxy can comprise an amine catalyst.

A coreactive composition can comprise from 0.1 wt % to 1 wt %, from 0.2 wt % to 0.9 wt %, from 0.3 wt % to 0.7 wt %, or from 0.4 wt % to 0.6 wt % of a catalyst or combination of catalysts, where wt % is based on the total weight of the coreactive composition.

A catalyst can include a latent catalyst or combination of latent catalysts. Latent catalysts include catalysts that have little or no activity until released or activated by physical and/or chemical mechanisms. Latent catalysts may be contained within a structure or may be chemically blocked. A controlled release catalyst may release a catalyst upon exposure to ultraviolet radiation, heat, ultrasonication, or moisture. A latent catalyst can be sequestered within a core-shell structure or trapped within a matrix of a crystalline or semi-crystalline polymer where the catalyst can diffuse from the encapsulant with time or upon activation such as by the application of thermal or mechanical energy.

A coreactive composition can comprise a dark cure catalyst or a combination of dark cure catalysts. A dark cure catalyst refers to a catalyst capable of generating free radicals without being exposed to electromagnetic energy.

Dark cure catalysts include combinations of metal complexes and organic peroxides, tialkylborane complexes, and peroxide-amine redox initiators. A dark cure catalyst can be used in conjunction with a photopolymerization initiator or independent of a photopolymerization initiator.

### Cure Activator

A coreactive composition based on thiol/thiol curing chemistries can comprise a cure activator or a combination of cure activators to initiate the thiol/thiol polymerization reaction. Cure activators can be used in coreactive compositions in which both the first compound and the second compound comprise thiol-terminated sulfur-containing prepolymers, such as thiol-terminated polysulfide prepolymers.

A cure activator can comprise an oxidizing agent capable of oxidizing terminal mercaptan groups to form disulfide bonds. Suitable oxidizing agents can include lead dioxide, manganese dioxide, calcium dioxide, sodium perborate monohydrate, calcium peroxide, zinc peroxide, and dichromate.

A cure activator can comprise an inorganic activator, an organic activator, or a combination thereof.

Suitable inorganic activators can include metal oxides. Suitable metal oxide activators may include zinc oxide (ZnO), lead oxide (PbO), lead peroxide (PbO₃), manganese dioxide (MnO₂), sodium perborate (NaBO₃·H₂O), potassium permanganate (KMnO₄), calcium peroxide (CaCO₃), barium peroxide (BaO₃), cumene hydroperoxide, and combinations of any of the foregoing. A cure activator can be MnO₂.

A coreactive composition based on thiol/thiol curing chemistries can comprise from 1 wt % to 10 wt % of a cure activator or combination of cure activators, wherein wt % is based on the total weight of the composition. S coreactive composition can comprise from 1 wt % to 9 wt %, from 2 wt % to 8 wt %, from 3 wt % to 7 wt %, or from 4 wt % to 6 wt % of an activator or a combination of cure activators, wherein wt % is based on the total weight of the composition. A coreactive composition can comprise greater than 1 wt % of a cure activator or a combination of cure activators, greater than 2 wt %, greater than 3 wt %, greater than 4 wt %, greater than 5 wt %, or greater than 6 wt % of a cure actuator or combination of cure activators, wherein wt % is based on the total weight of the composition.

A coreactive composition based on thiol/thiol curing chemistries can include a cure accelerator or combination of cure accelerators.

A cure accelerator can act as sulfur donors to generate active sulfur fragments capable of reacting with the terminal thiol groups of a thiol-terminated polysulfide prepolymer.

Suitable cure accelerators may include thiazoles, thiurams, sulfenamides, guanidines, dithiocarbamates, xanthates, thioureas, aldehydeamines, and combinations of any of the foregoing.

A cure accelerator can be thiuram polysulfide, a thiuram disulfide, or a combination thereof.

Other suitable cure accelerators also include triazines and sulfides or metallic and amine salts of dialkyldithiophosphoric acids and dithiophosphates such as triazines and sulfides or metallic and amine salts of dialkyldithiophosphoric acids, and combinations of any of the foregoing. Non-sulfur-containing cure accelerators include tetramethyl guanidine (TMG), di-o-tolyl guanidine (DOTG), sodium hydroxide (NaOH), water and bases.

A coreactive composition can comprise from 0.01 wt % to 2 wt % of a cure accelerator or combination of cure accelerators, from 0.05 wt % to 1.8 wt %, from 0.1 wt % to 1.6 wt %, or from 0.5 wt % to 1.5 wt % of a cure accelerator or combination of cure accelerators, where wt % is based on the total weight of the composition. A coreactive composition can comprise less than 2 wt %, less than 1.8 wt %, less than 1.6 wt %, less than 1.4 wt %, less than 1.2 wt %, less than 1 wt %, less than 0.5 wt %, less than 0.1 wt %, or less than 0.05 wt % of a cure accelerator or combination of cure accelerators, where wt % is based on the total weight of the composition.

### Adhesion Promoters

A coreactive composition can comprise an adhesion promoter or combination of adhesion promoters. Adhesion promoters can enhance the adhesion of a coreactive composition to an underlying substrate such as a metal, composite, polymeric, or a ceramic surface, or to a coating such as a primer coating or other coating layer. Adhesion promoters can enhance adhesion to cabin panels.

An adhesion promoter can include a phenolic adhesion promoter, a combination of phenolic adhesion promoters, an organo-functional silane, a combination of organo-functional silanes, or a combination of any of the foregoing. An organo-functional alkoxysilane can be an amine-functional alkoxysilane. The organo group can be selected from a thiol group, an amine group, a hydroxyl group, a silanol group an epoxy group, an alkynyl group, an alkenyl group, an isocyanate group, or a Michael acceptor group.

A phenolic adhesion promoter can comprise a cooked phenolic resin, an un-cooked phenolic resin, or a combination thereof. Suitable adhesion promoters may include phenolic resins such as Methylon® phenolic resin, and organosilanes, such as epoxy-, mercapto- or amine-functional silanes, such as Silquest® organosilanes. A cooked phenolic resin refers to a phenolic resin that has been co-reacted with a monomer, oligomer, and/or prepolymer.

A phenolic adhesion promoter can comprise the reaction product of a condensation reaction of a phenolic resin with one or more thiol-terminated polysulfides. Phenolic adhesion promoters can be thiol-terminated.

Suitable phenolic resins can include 2-(hydroxymethyl)phenol, (4-hydroxy-1,3-phenylene)dimethanol, (2-hydroxybenzene-1,3,4-triyl) trimethanol, 2-benzyl-6-(hydroxymethyl)phenol, (4-hydroxy-5-((2-hydroxy-5-(hydroxymethyl)cyclohexa-2,4-dien-1-yl)methyl)-1,3-phenylene)dimethanol, (4-hydroxy-5-((2-hydroxy-3,5-bis(hydroxymethyl)cyclohexa-2,4-dien-1-yl)methyl)-1,3-phenylene)dimethanol, and a combination of any of the foregoing. Suitable phenolic resins can be synthesized by the base-catalyzed reaction of phenol with formaldehyde. Phenolic adhesion promoters can comprise the reaction product of a condensation reaction of a Methylon® resin, a Varcum® resin, or a Durez® resin available from Durez Corporation with a thiol-terminated polysulfide such as a Thioplast® resin. Methylon® resins may include Methylon® 75108 (allyl ether of methylol phenol, see U.S. Pat. No. 3,517,082) and Methylon® 75202. Varcum® resins may include Varcum® 29101, Varcum® 29108, Varcum® 29112, Varcum® 29116, Varcum® 29008, Varcum® 29202, Varcum® 29401, Varcum® 29159, Varcum® 29181, Varcum® 92600, Varcum® 94635, Varcum® 94879, and Varcum®94917. S Durez® resin may Durez® 34071.

A coreactive composition can comprise an organo-functional alkoxysilane adhesion promoter such as an organo-functional alkoxysilane. An organo-functional alkoxysilane can comprise hydrolysable groups bonded to a silicon atom and at least one organofunctional group. An organo-functional alkoxysilane can have the structure R^{a}—(CH₂)ₙ—Si(—OR)₃₋ₙRₙ, where R^{a} is an organofunctional group, n is 0, 1, or 2, and R is alkyl such as methyl or ethyl. Organofunctional groups may include epoxy, amino, methacryloxy, or sulfide groups. An organo-functional alkoxysilane can be a dipodal alkoxysilane having two or more alkoxysilane groups, a functional dipodal alkoxysilane, a non-functional dipodal alkoxysilane or a combination of any of the foregoing. An organofunctional alkoxysilane can be a combination of a monoalkoxysilane and a dipodal alkoxysilane.

Suitable amino-functional alkoxysilanes under the Silquest® tradename may include Silquest® A-1100 (γ-aminopropyltriethoxysilane), Silquest® A-1108 (γ-aminopropylsilsesquioxane), Silquest® A-1110 (γ-aminopropyltrimethoxysilane), Silquest® 1120 (N-β-(aminoethyl)-γ-aminopropyltrimethoxysilane), Silquest® 1128 (benzylamino-silane), Silquest® A-1130 (triaminofunctional silane), Silquest® Y-11699 (bis-(γ-triethoxysilylpropyl)amine), Silquest® A-1170 (bis-(γ-trimethoxysilylpropyl)amine), Silquest® A-1387 (polyazamide), Silquest® Y-19139 (ethoxy-based polyazamide), and Silquest® A-2120 (N-β-(aminoethyl)-γ-aminopropylmethyldimethoxysilane). Suitable amine-functional alkoxysilanes are commercially available from Gelest Inc, from Dow Corning Corporation, and Momentive Performance Materials, Inc.

### Filler

A coreactive composition can comprise a filler or combination of filler. A filler can comprise inorganic filler, organic filler, low-density filler, conductive filler, or a combination of any of the foregoing.

A coreactive composition for forming a linear sealing component can comprise an inorganic filler or combination of inorganic filler.

An inorganic filler can be included to provide mechanical reinforcement and to control the rheological properties of the composition such as the viscosity. Inorganic filler may be added to compositions to impart desirable physical properties such as to increase the impact strength, to control the viscosity, and/or to modify the electrical properties of a cured composition.

Inorganic filler useful in coreactive compositions include carbon black, calcium carbonate, precipitated calcium carbonate, calcium hydroxide, hydrated alumina (aluminum hydroxide), talc, mica, titanium dioxide, alumina silicate, carbonates, chalk, silicates, glass, metal oxides, graphite, and combinations of any of the foregoing.

Suitable calcium carbonate filler include products such as Socal® 31, Socal® 312, Socal® U1S1, Socal® UaS2, Socal® N2R, Winnofil® SPM, and Winnofil® SPT available from Solvay Special Chemicals. A calcium carbonate filler can include a combination of precipitated calcium carbonates.

Inorganic filler can be surface treated to provide hydrophobic or hydrophilic surfaces that can facilitate dispersion and compatibility of the inorganic filler with other components of a coreactive composition. An inorganic filler can include surface-modified particles such as surface modified silica. The surface of silica particles can be modified to be tailor the hydrophobicity or hydrophilicity of the surface of the silica particle. The surface modification can affect the dispensability of the particles, the viscosity, the curing rate, and/or the adhesion.

A coreactive composition can comprise an organic filler or a combination of organic fillers.

Organic filler can be selected to have a low specific gravity and to be resistant to solvents such as JRF Type I and/or to reduce the density of a sealant layer. Suitable organic filler can also have acceptable adhesion to the sulfur-containing polymer matrix. An organic filler can include solid powders or particles, hollow powders or particles, or a combination thereof.

An organic filler can have a specific gravity such as less than 1.15, less than 1.1, less than 1.05, less than 1, less than 0.95, less than 0.9, less than 0.8, or less than 0.7. Organic filler can have a specific gravity such as within a range from 0.85 to 1.15, within a range from 0.9 to 1.1, within a range from 0.9 to 1.05, or from 0.85 to 1.05.

Organic filler can comprise thermoplastics, thermosets, or a combination thereof. Suitable thermoplastics and thermosets may include epoxies, epoxy-amides, ETFE copolymers, nylons, polyethylenes, polypropylenes, polyethylene oxides, polypropylene oxides, polyvinylidene chlorides, polyvinylfluorides, TFE, polyamides, polyimides, ethylene propylenes, perfluorohydrocarbons, fluoroethylenes, polycarbonates, polyetheretherketones, polyetherketones, polyphenylene oxides, polyphenylene sulfides, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, or combinations of any of the foregoing.

Suitable polyamide 6 and polyamide 12 particles may be available from Toray Plastics as grades SP-500, SP-10, TR-1, and TR-2. Suitable polyamide powders are also available from the Arkema Group under the tradename Orgasol®, and from Evonik Industries under the tradename Vestosin®.

An organic filler can have any suitable shape. An organic filler can comprise fractions of crushed polymer that has been filtered to select a desired size range. An organic filler can comprise substantially spherical particles. Particles can be solid or can be porous.

An organic filler can have an average particle size such as within a range from 1 μm to 100 μm, 2 μm to 40 μm, from 2 μm to 30 μm, from 4 μm to 25 μm, from 4 μm to 20 μm, from 2 μm to 12 μm, or from 5 μm to 15 μm. An organic filler can have an average particle size such as less than 100 μm, less than 75 μm, less than 50 μm, less than 40 μm, or less than 20 μm. Particle size distribution can be determined using a Fischer Sub-Sieve Sizer or by optical inspection.

### Low-Density Filler

A coreactive composition for forming a linear sealing component that exhibits a low-density can comprise low-density filler such as low-density organic filler, hollow microspheres, coated microspheres, or combinations of any of the foregoing. Low-density fillers may also be referred to as lightweighting fillers.

A linear sealing component can exhibit a specific gravity such as less than 1.1, less than 1.0, less than 0.9, less than 0.8, or less than 0.7, where specific gravity is determined according to ISO 2781 at 23° C./55% RH.

An organic filler can include a low-density such as a modified, expanded thermoplastic microcapsules. Suitable modified expanded thermoplastic microcapsules can include an exterior coating of a melamine or urea/formaldehyde resin. A coreactive composition can comprise low-density microcapsules. A low-density microcapsule can comprise a thermally expandable microcapsule.

A thermally expandable microcapsule refers to a hollow shell comprising a volatile material that expands at a predetermined temperature. Thermally expandable thermoplastic microcapsules can have an average initial particle size of 5 μm to 70 μm, in some cases 10 μm to 24 μm, or from 10 μm to 17 μm. The term “average initial particle size” refers to the average particle size (numerical weighted average of the particle size distribution) of the microcapsules prior to any expansion. The particle size distribution can be determined using a Fischer Sub-Sieve Sizer or by optical inspection.

Materials suitable for forming the wall of a thermally expandable microcapsule may include polymers of vinylidene chloride, acrylonitrile, styrene, polycarbonate, methyl methacrylate, ethyl acrylate, and vinyl acetate, copolymers of these monomers, and combinations of the polymers and copolymers. A crosslinking agent may be included with the materials forming the wall of a thermally expandable microcapsule.

Suitable thermoplastic microcapsules may include Expancel™ microcapsules such as Expancel® DE microspheres available from AkzoNobel. Suitable Expancel™ DE microspheres may include Expancel®920 DE 40 and Expancel® 920 DE 80. Suitable low-density microcapsules are also available from Kureha Corporation.

Low-density filler such as low-density microcapsules can be characterized by a specific gravity within a range from 0.01 to 0.09, from 0.04 to 0.09, within a range from 0.04 to 0.08, within a range from 0.01 to 0.07, within a range from 0.02 to 0.06, within a range from 0.03 to 0.05, within a range from 0.05 to 0.09, from 0.06 to 0.09, or within a range from 0.07 to 0.09, wherein the specific gravity is determined according to ASTM D1475. Low-density filler such as low-density microcapsules can be characterized by a specific gravity less than 0.1, less than 0.09, less than 0.08, less than 0.07, less than 0.06, less than 0.05, less than 0.04, less than 0.03, or less than 0.02, wherein the specific gravity is determined according to ASTM D1475.

Low-density filler such as low microcapsules can be characterized by a mean particle diameter from 1 μm to 100 μm and can have a substantially spherical shape. Low-density filler such as low-density microcapsules can be characterized by a mean particle diameter from 10 μm to 100 μm, from 10 μm to 60 μm, from 10 μm to 40 μm, or from 10 μm to 30 μm, as determined according to ASTM D1475.

Low-density filler such as low-density microcapsules can comprise expanded microcapsules or microballoons having a coating of an aminoplast resin such as a melamine resin. Aminoplast resin-coated particles are described in U.S. Pat. No. 8,993,691. Such microcapsules can be formed by heating a microcapsule comprising a blowing agent surrounded by a thermoplastic shell. Uncoated low-density microcapsules can be reacted with an aminoplast resin such as a urea/formaldehyde resin to provide a coating of a thermoset resin on the outer surface of the particle.

With the coating of an aminoplast resin, an aminoplast-coated microcapsule can be characterized by a specific gravity within a range from 0.02 to 0.08, within a range from 0.02 to 0.07, within a range from 0.02 to 0.06, within a range from 0.03 to 0.07, within a range from 0.03 to 0.065, within a range from 0.04 to 0.065, within a range from 0.045 to 0.06, or within a range from 0.05 to 0.06, wherein the specific gravity is determined according to ASTM D1475.

A coreactive composition can comprise micronized oxidized polyethylene homopolymer. An organic filler can include a polyethylenes, such as an oxidized polyethylene powder. Suitable polyethylenes may be available from Honeywell International, Inc. under the tradename ACumist®, from INEOS under the tradename Eltrex®, and Mitsui Chemicals America, Inc. under the tradename Mipelon®.

A coreactive composition can comprise from 1 wt % to 90 wt % of low-density filler, from 1 wt % to 60 wt %, from 1 wt % to 40 wt %, from 1 wt % to 20 wt %, from 1 wt % to 10 wt %, or from 1 wt % to 5 wt % of low-density filler, where wt % is based on the total weight of the composition.

A coreactive composition can comprise greater than 1 wt % low-density filler, greater than 1 wt %, greater than 2 wt %, greater than 3 wt %, greater than 4 wt %, greater than 1 wt %, or greater than 10 wt % low-density filler, where wt % is based on the total weight of the composition.

A coreactive composition can comprise from 1 vol % to 90 vol % low-density filler, from 5 vol % to 70 vol %, from 10 vol % to 60 vol %, from 20 vol % to 50 vol %, or from 30 vol % to 40 vol % low-density filler, where vol % is based on the total volume of the coreactive composition.

A coreactive composition can comprise greater than 0.5 vol % of low-density filler, greater than 1 vol %, greater than 5 vol %, greater than 10 vol %, greater than 20 vol %, greater than 30 vol %, greater than 40 vol %, greater than 50 vol %, greater than 60 vol %, greater than 70 vol %, or greater than 80 vol % low-density filler, where vol % is based on the total volume of the coreactive composition.

### Conductive Filler

A coreactive composition can include a conductive filler or a combination of conductive filler. A conductive filler can include electrically conductive filler, semiconductive filler, thermally conductive filler, magnetic filler, EMI/RFI shielding filler, static dissipative filler, electroactive filler, or a combination of any of the foregoing.

Suitable conductive fillers such as electrically conductive filler may include metals, metal alloys, conductive oxides, semiconductors, carbon, carbon fiber, and combinations of any of the foregoing.

Other electrically conductive fillers can include electrically conductive noble metal-based filler such as pure silver; noble metal-plated noble metals such as silver-plated gold; noble metal-plated non-noble metals such as silver plated cooper, nickel or aluminum, silver-plated aluminum core particles or platinum-plated copper particles; noble-metal plated glass, plastic or ceramics such as silver-plated glass microspheres, noble-metal plated aluminum or noble-metal plated plastic microspheres; noble-metal plated mica; and other such noble-metal conductive filler. Non-noble metal-based materials can also be used and include non-noble metal-plated non-noble metals such as copper-coated iron particles or nickel-plated copper; non-noble metals, e.g., copper, aluminum, nickel, cobalt; non-noble-metal-plated-non-metals, e.g., nickel-plated graphite and non-metal materials such as carbon black and graphite. Combinations of electrically conductive filler and shapes of electrically conductive filler can be used to achieve a desired conductivity, EMI/RFI shielding effectiveness, hardness, and other properties suitable for a particular application.

The amount and type of electrically conductive filler can be selected to produce a coreactive composition which, when cured, exhibits a sheet resistance (four-point resistance) of less than 0.50 Ω/cm², or a sheet resistance less than 0.15 Ω/cm². The amount and type of filler can also be selected to provide effective EMI/RFI shielding over a frequency range of from 1 MHz to 18 GHz for an aperture sealed using a coreactive composition.

Organic filler, inorganic filler, and low-density filler can be coated with a metal to provide conductive filler.

An electrically conductive filler can include graphene. Graphene comprises a densely packed honeycomb crystal lattice made of carbon atoms having a thickness equal to the atomic size of one carbon atom, i.e., a monolayer of sp² hybridized carbon atoms arranged in a two-dimensional lattice.

Conductive filler can comprise magnetic filler or combination of magnetic filler.

The magnetic filler can include a soft magnetic metal. This can enhance permeability of the magnetic mold resin. As a main component of the soft magnetic metal, at least one magnetic material selected from Fe, Fe—Co, Fe—Ni, Fe—Al, and Fe—Si may be used. A magnetic filler can be a soft magnetic metal having a high bulk permeability. As the soft magnetic metal, at least one magnetic material selected can be Fe, FeCo, FeNi, FeAl, and FeSi may be used such as a permalloy (FeNi alloy), a super permalloy (FeNiMo alloy), a sendust (FeSiAl alloy), an FeSi alloy, an FeCo alloy, an FeCr alloy, an FeCrSi alloy, FeNiCo alloy, and Fe. Other magnetic filler may include iron-based powder, iron-nickel based powder, iron powder, ferrite powder, Alnico powder, Sm₂Co₁₇ powder, Nd—B—Fe powder, barium ferrite BaFe₂O₄, bismuth ferrite BiFeO₃, chromium dioxide CrO₂, SmFeN, NdFeB, and SmCo.

### Reactive Diluents

A coreactive composition can comprise a hydroxyl-functional vinyl ether or combination of hydroxyl-functional vinyl ethers. A reactive diluent can be used to reduce the viscosity of the composition. A reactive diluent can be a low molecular weight compound such as having a molecular weight less than 400 Da having at least one functional group capable of reacting with at least one of the major reactants of the composition and become part of the cross-linked network. A reactive diluent can have one functional group or two functional groups. A reactive dilute can be used to control the viscosity of a composition or improve the wetting of filler in a coreactive composition.

A hydroxyl-functional vinyl ether can have the structure of Formula (12):

CH₂=CH—O—(CH₂)ᵣ—OH (12)

where t is an integer from 2 to 10. In hydroxyl-functional vinyl ethers of Formula (12), t can be 1, 2, 3, 4, 5, or t can be 6. Suitable hydroxyl-functional vinyl ethers may include 1-methyl-3-hydroxypropyl vinyl ether, 4-hydroxybutyl vinyl ether, and a combination thereof.

A hydroxyl-functional vinyl ether can be 4-hydroxybutyl vinyl ether.

A coreactive composition can comprise from 0.1 wt % to 10 wt % of a hydroxyl-functional vinyl ether, from 0.2 wt % to 9 wt %, from 0.3 wt % to 0.7 wt % and from 0.4 wt % to 0.7 wt %, where wt % is based on the total weight of the curable composition.

A coreactive composition can comprise an amino-functional vinyl ether or combination of amino-functional vinyl ethers as a reactive diluent.

An amino-functional vinyl ether can have the structure of Formula (13):

CH₂=CH—O—(CH₂)_{w}—NH₂ (13)

where w is an integer from 2 to 10. In amino-functional vinyl ethers of Formula (13), w can be 1, 2, 3, 4, 5, or t can be 6. Suitable amino-functional vinyl ethers may include 1-methyl-3-aminopropyl vinyl ether, 4-aminobutyl vinyl ether, and a combination of any of the foregoing. An amino-functional vinyl ether can be 4-aminobutyl vinyl ether as a reactive diluent.

A coreactive composition can comprise from 0.1 wt % to 10 wt % of an amino-functional vinyl ether, from 0.2 wt % to 9 wt %, from 0.3 wt % to 0.7 wt % and from 0.4 wt % to 0.7 wt %, where wt % is based on the total weight of the coreactive composition.

A coreactive composition can comprise vinyl-based diluents such as styrene, α-methyl styrene and para-vinyl toluene; vinyl acetate; and/or n-vinyl pyrrolidone as a reactive diluent.

### Plasticizers

A coreactive composition can contain a plasticizer or a combination of plasticizers. Plasticizers can be included to adjust the viscosity of the composition and to facilitate application.

Suitable plasticizers can include a combination of phthalates, terephathlic, isophathalic, hydrogenated terphenyls, quaterphenyls and higher or polyphenyls, phthalate esters, chlorinated paraffins, modified polyphenyl, tung oil, benzoates, dibenzoates, thermoplastic polyurethane plasticizers, phthalate esters, naphthalene sulfonate, trimellitates, adipates, sebacates, maleates, sulfonamides, organophosphates, polybutene, butyl acetate, butyl cellosolve, butyl carbitol acetate, dipentene, tributyl phosphate, hexadecanol, diallyl phthalate, sucrose acetate isobutyrate, epoxy ester of iso-octyl tallate, benzophenone and combinations of any of the foregoing.

A coreactive composition can comprise from 0.5 wt % to 7 wt % of a plasticizer or combination of plasticizers from 1 wt % to 6 wt %, from 2 wt % to 5 wt % or from 2 wt % to 4 wt % of a plasticizer or combination of plasticizers, where wt % is based on the total weight of the coreactive composition.

A coreactive composition can comprise less than 8 wt % plasticizer, less than 6 wt %, less than 4 wt %, or less than 2 wt % of a plasticizer or combination of plasticizers, where wt % is based on the total weight of the coreactive composition.

### Photochromic Agents

A coreactive composition can comprise a photochromic agent sensitive to the degree of cure or the extent of exposure to actinic radiation. A cure indicator can change color upon exposure to actinic radiation, which can be permanent or reversible. A cure indicator can be initially transparent and become colored upon exposure to actinic radiation or can be initially colored and become transparent upon exposure to actinic radiation.

### Corrosion Inhibitors

A coreactive composition provided by the present disclosure can comprise a corrosion inhibitor or combination of corrosion inhibitors.

Suitable corrosion inhibitors can include zinc phosphate-based corrosion inhibitors, a lithium silicate corrosion inhibitor such as lithium orthosilicate (Li₄SiO₄) and lithium metasilicate (Li₂SiO₃), MgO, an azole, a monomeric amino acid, a dimeric amino acid, an oligomeric amino acid, a nitrogen-containing heterocyclic compound such as an azole, oxazole, thiazole, thiazolines, imidazole, diazole, pyridine, indolizine, and triazine, tetrazole, and/or tolyltriazole, corrosion resistant particles such as inorganic oxide particles, including zinc oxide (ZnO), magnesium oxide (MgO), cerium oxide (CeO₂), molybdenum oxide (MoO₃), and/or silicon dioxide (SiO₂), and combinations of any of the foregoing.

A coreactive composition can comprise less than 5 wt % of a corrosion inhibitor or combination of corrosion inhibitors, less than 3 wt %, less than 2 wt %, less than 1 wt %, or less than 0.5 wt % of a corrosion inhibitor or combination of a corrosion inhibitors, where wt % is based on the total weight of the coreactive composition.

### Fire Retardants

A coreactive composition can comprise a fire retardant or combination of fire retardants.

A fire retardant can include an inorganic fire retardant, an organic fire retardant, or a combination thereof.

Suitable inorganic fire retardants may include aluminum hydroxide, magnesium hydroxide, zinc borate, antimony oxides, hydromagnesite, aluminum trihydroxide (ATH), calcium phosphate, titanium oxide, zinc oxide, magnesium carbonate, barium sulfate, barium borate, kaolinite, silica, antimony oxides, and combinations of any of the foregoing.

Suitable organic fire retardants include halocarbons, halogenated esters, halogenated ethers, chlorinated and/or brominated flame retardants, halogen free compounds such as organophosphorus compounds, organonitrogen compounds, and combinations of any of the foregoing. Fire retardants may be in the form of solid (e.g., powder) or liquid.

A coreactive composition can comprise from 1 wt % to 30 wt %, such as from 1 wt % to 20 wt %, or from 1 wt % to 10 wt % of a flame retardant or combination of flame retardants based on the total weight of the coreactive composition. A coreactive composition can comprise less than 30 wt %, less than 20 wt %, less than 10 wt %, less than 5 wt %, or less than 2 wt %, of a flame retardant or combination of flame retardants based on the total weight of the coreactive composition.

### Moisture Control Additives

A coreactive composition can comprise a moisture control additive or combination of moisture control additives.

Suitable moisture control additives may include synthetic zeolite, activated alumina, silica gel, calcium oxide, magnesium oxide, molecular sieve, anhydrous sodium sulphate, anhydrous magnesium sulphate, alkoxysilanes, and combinations of any of the foregoing.

A coreactive composition can comprise less than 5 wt % of a moisture control additive or combination of moisture control additives, less than 3 wt %, less than 2 wt %, less than 1 wt %, or less than 0.5 wt % of a moisture control additive or combination of a moisture control additives, where wt % is based on the total weight of the coreactive composition.

### UV Stabilizers

A coreactive composition can comprise a UV stabilizer or a combination of UV stabilizers. UV stabilizers include UV absorbers and hindered amine light stabilizers. Suitable UV stabilizers may include products under the tradenames Cyasorb® (Solvay), Uvinul® (BASF), and Tinuvin® (BASF).

### Additively Manufacturing a Linear Sealing Component

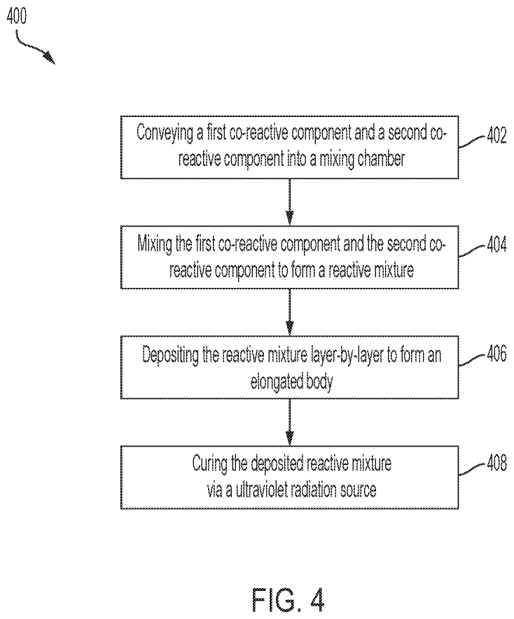

FIG. 4 is a simplified diagram showing a method 400 for additively manufacturing a linear sealing component. Method 400 includes a process 402 of conveying a first co-reactive component and a second co-reactive component into a mixing chamber, a process 404 of mixing the first co-reactive component and the second co-reactive component to form a reactive mixture, a process 406 of depositing the reactive mixture layer-by-layer to form an elongated body, and a process 408 of curing the deposited reactive mixture via an actinic radiation source. Although the above has been shown using a selected group of processes for the method, there can be many alternatives, modifications, and variations. Some of the processes may be expanded and/or combined. Other processes may be inserted to those noted above. Some processes may be removed or replaced. Depending upon the embodiment, the sequence of processes may be interchanged.

Process 402 of conveying a first co-reactive component and a second co-reactive component into a mixing chamber can includes conveying (e.g., pumping) the first co-reactive component from a first reservoir and the second co-reactive component from a second reservoir into the mixing chamber. The first co-reactive component may includes a sulfur-containing prepolymer, which may comprise a polythioether, a polysulfide, a sulfur-containing polyformal, a monosulfide, or a combination of any of the foregoing. The first co-reactive component may include a thiol-terminated polythioether, the second co-reactive component includes a polyene prepolymer, which may be a polyvinyl ether. The first co-reactive component and/or the second co-reactive component can further includes flame retardant filler particles, rheology-modifying filler particles (e.g., organic and/or inorganic), lightweighting filler particles, and/or sound dampening filler particles.

Process 404 of mixing the first co-reactive component and the second co-reactive component to form a reactive mixture may includes actively (e.g., via a propeller) and/or passively (e.g., via chamber's static structures) mixing the co-reactive components to form a homogeneous reactive mixture. The reactive mixture may be partially cured within the mixing chamber before deposition to obtain desirable rheological characteristics and/or self-supporting strength (e.g., to enable overhang-printing and/or prevent gravity-induced deformation such as sag). In some scenarios, air bubbles may be removed from the reactive mixture before deposition such that printing imperfections that may lead to acoustic weak spots (e.g., acoustically leaky spots) may be minimized.

Process 406 of depositing the reactive mixture layer-by-layer to form an elongated body may include guiding an extrusion nozzle using a controller (e.g., of a computer), applying pressure(s) to the mixing chamber (e.g., via pressurizing the reservoirs connected thereto) to extrude the reactive mixture to form the elongated body of the linear sealing component.

Process 408 of curing the deposited reactive mixture via an actinic radiation source may include exposing the elongated body and/or reactive mixture extruded out of the extrusion nozzle with actinic radiation (e.g., ultraviolet radiation) during depositing, and/or after deposition. The mixing chamber may be actinic radiation-transparent such that actinic radiation may be applied while the reactive mixture is within the mixing chamber to partially cure the reactive mixture before deposition. The actinic radiation source may be spaced 20 to 30 inches away from the extrusion nozzle and/or the mixing chamber, such as 23 inches away. The actinic radiation source may be covered with one layer of polarizing film towards the direction of the extrusion nozzle. The actinic radiation source may be a 395 nm ultraviolet lamp with a baseline intensity of 230 mW/cm². Once the linear sealing component is printed, deposition stops and a secondary curing step may be implemented, such as with the same 395 nm ultraviolet lamp in a aluminum foil-lined chamber for at least 30 more minutes. Upon curing, the elongated body may have a porous structure, such as having closed porous structure in its walls.

Linear sealing components can be fabricated using coreactive three-dimensional printing.

Coreactive three-dimensional printing refers to robotic manufacturing methods in which a coreactive composition is extruded through a nozzle and deposited using automated control. In coreactive three-dimensional printing a one-part coreactive composition can be pumped into the three-dimensional printing apparatus and the curing reaction can be initiated by application of energy such as by exposing the coreactive composition to ultraviolet radiation. Alternatively, at least two coreactive components can be combined and mixed to form a coreactive composition, which can then be extruded through a nozzle and deposited. Upon mixing, the coreactive compounds can react at a temperature such as less than 30° C. such as from 20° C. to 25° C. and begin curing to form a thermoset polymer matrix. Alternatively, after mixing the coreactive compounds do not initially react when first combined and the reaction can be initiated by exposing the coreactive composition to energy such as ultraviolet radiation.

Three-dimensional printing equipment for fabricating a part can comprise one or more pumps, one or more mixers, and one or more nozzles. One or more coreactive compositions can be pumped into the one or more mixers and forced under pressure through one or more nozzles directed onto a surface or a previously applied layer.

The three-dimensional printing equipment can comprise pressure controls, extrusion dies, coextrusion dies, coating applicators, temperature control elements, elements for applying energy to the coreactive composition, or combinations of any of the foregoing.

The three-dimensional printing equipment can comprise a build apparatus for moving a nozzle in three dimensions with respect to a surface. The motion of the three-dimensional printing apparatus can be controlled by a processor.

A linear sealing components can be fabricated by forming successive portions or layers of an article by depositing a coreactive composition comprising at least two coreactive components and thereafter depositing additional portions or layers of the coreactive composition over the underlying deposited portion or layer and/or adjacent the previously deposited portion or layer. Layers can be successively deposited on top of and/or adjacent a previously deposited layer to build a sound-resistant part. A coreactive composition can be mixed and then deposited or the coreactive components can be deposited separately. When deposited separately, the coreactive components can be deposited simultaneously, sequentially, or both simultaneously and sequentially.

A coreactive composition can be deposited using any suitable coreactive three-dimensional printing apparatus. The selection of a suitable coreactive three-dimensional printing apparatus can depend on a number of factors including the deposition volume, the viscosity of the coreactive composition, the deposition rate, the reaction rate of the coreactive compounds, and the complexity and size of the chemically resistant part being fabricated. Each of the two or more coreactive components can be introduced into an independent pump and injected into a mixer to combine and mix the two coreactive components to form the coreactive composition. A nozzle can be coupled to the mixer and the mixed coreactive composition can be forced under pressure or extruded through the nozzle.

A pump can be a positive displacement pump, a syringe pump, a piston pump, or a progressive cavity pump. The two pumps delivering the two coreactive components can be placed in parallel or placed in series. A suitable pump can be capable of pushing a liquid or viscous liquid through a nozzle orifice. This process can also be referred to as extrusion. A coreactive component can also be introduced into the mixer using two pumps in series.

Two or more coreactive components can be deposited by dispensing materials through a disposable nozzle attached to a progressive cavity two-component system where the coreactive components are mixed in-line. A two-component system can comprise two progressive cavity pumps that separately dose coreactive components into a disposable static mixer dispenser or into a dynamic mixer. Other suitable pumps include positive displacement pumps, syringe pumps, piston pumps, and progressive cavity pumps. After mixing to form a coreactive composition, the coreactive composition forms an extrudate as it is forced under pressure through one or more dies and/or one or nozzles to be deposited onto a base to provide an initial layer of a chemically resistant part, and successive layers can be deposited onto and/or adjacent a previously deposited layer. The deposition system can be positioned orthogonal to the base, but also may be set at any suitable angle to form the extrudate such that the extrudate and deposition system form an obtuse angle with the extrudate being parallel to the base. The extrudate refers to the coreactive composition after the coreactive components are mixed in a static mixer or in a dynamic mixer. The extrudate can be shaped upon passing through a die and/or nozzle.

The base, the deposition system, or both the base and the deposition system may be articulate to build up a three-dimensional chemically resistant part. The motion can be made in a predetermined manner, which may be accomplished using any suitable CAD/CAM method and apparatus such as robotics and/or computerize machine tool interfaces.

An extrudate formed by extruding a coreactive composition through a nozzle of a three-dimensional printing apparatus can be deposited in any orientation. The nozzle can be directed downwards, upwards, sideways, or at any angle in between. In this way a coreactive composition can be deposited as a vertical wall or as an overhang. An extrudate can be deposited on a vertical wall, the lower surface of a tilted wall, or on the bottom of a horizontal surface. The use of an extrudate with a fast curing chemistry can facilitate the ability of an overlying layer to be deposited adjoining an underlying layer such that an angled surface can be fabricated. The angled surface can tilt upward with respect to horizontal or downward with respect to horizontal.

An extrudate may be dispensed continuously or intermittently to form an initial layer and successive layers. For intermittent deposition, a deposition system may interface with a switch to shut off the pumps, such as the progressive cavity pumps and thereby interrupt the flow of the coreactive composition.

A three-dimensional printing system can include an in-line static and/or dynamic mixer as well as separate pressurized pumping compartments to hold the at least two coreactive components and feed the coreactive components into the static and/or dynamic mixer. A mixer such as an active mixer can comprise a variable speed central impeller having high shear blades within a nozzle. A range of nozzles may be used which have a minimum dimension such as from 0.2 mm to 100 mm, from 0.5 mm to 75 mm, from 1 mm to 50 mm, or from 5 mm to 25 mm. A nozzle can have a minimum dimension such as greater than 1 mm, greater than 2 mm, greater than 5 mm, greater than 10 mm, greater than 20 mm, greater than 30 mm, greater than 40 mm, greater than 50 mm, greater than 60 mm, greater than 70 mm, greater than 80 mm, or greater than 90 mm. A nozzle can have a minimum dimension such as less than 100 mm, less than 90 mm, less than 80 mm, less than 70 mm, less than 60 mm, less than 50 mm, less than 40 mm, less than 30 mm, less than 20 mm, less than 10 mm, or less than 5 mm. A nozzle can have any suitable cross-sectional dimension such as round, spherical, oval, rectangular, square, trapezoidal, triangular, planar, or other suitable shape. The aspect ratio or ratio of the orthogonal dimensions can be any suitable dimensions as appropriate for fabricating a chemically resistant part such as a 1:1, greater than 1:2, greater than 1:3, greater than 1:5, or greater than 1:10.

A range of static and/or dynamic mixing nozzles may be used which have an exit orifice dimension from 0.6 mm to 2.5 mm, and a length from 30 mm to 150 mm. An exit orifice diameter can be from 0.2 mm to 4.0 mm, from 0.4 mm to 3.0 mm, from 0.6 mm to 2.5 mm, from 0.8 mm to 2 mm, or from 1.0 mm to 1.6 mm. A static mixer and/or dynamic can have a length from 10 mm to 200 mm, from 20 mm to 175 mm, from 30 mm to 150 mm, or from 50 mm to 100 mm. A mixing nozzle can include a static and/or dynamic mixing section and a dispensing section coupled to the static and/or dynamic mixing section. The static and/or dynamic mixing section can be configured to combine and mix the coreactive materials. The dispensing section can be a straight tube having any of the above orifice diameters. The length of the dispensing section can be configured to provide a region in which the coreactive components can begin to react and build viscosity before being deposited on the article. The length of the dispensing section can be selected based on the speed of deposition, the rate of reaction of the co-reactants, and the viscosity of the coreactive composition.

A coreactive composition can have a residence time in the static and/or dynamic mixing nozzle from 0.25 seconds to 5 seconds, from 0.3 seconds to 4 seconds, from 0.5 seconds to 3 seconds, or from 1 seconds to 3 seconds. Other residence times can be used as appropriate based on the curing chemistries and curing rates.

In general, a suitable residence time is less than the gel time of the coreactive composition.

A coreactive composition can have a volume flow rate from 0.1 mL/min to 20,000 mL/min, such as from 1 mL/min to 12,000 mL/min, from 5 mL/min to 8,000 mL/min, or from 10 mL/min to 6,000 mL/min. The volume flow rate can depend on the viscosity of a coreactive composition, the extrusion pressure, the nozzle diameter, and the reaction rate of the coreactive compounds.

A coreactive composition can be used at a deposition speed from 1 mm/sec to 400 mm/sec, such as from 5 mm/sec to 300 mm/sec, from 10 mm/sec to 200 mm/sec, or from 15 mm/sec to 150 mm/sec. The deposition speed can depend on the viscosity of the coreactive composition, the extrusion pressure, the nozzle diameter, and the reaction rate of the coreactive compounds. The deposition speed refers to the speed at which a nozzle used to extrude a coreactive composition moves with respect to a surface onto which the coreactive composition is being deposited.

A static and/or dynamic mixing nozzle can be heated or cooled to control the rate of reaction between the coreactive compounds and/or the viscosity of the coreactive components. An orifice of a deposition nozzle can have any suitable shape and dimensions. A system can comprise multiple deposition nozzles. The nozzles can have a fixed orifice dimension and shape, or the nozzle orifice can be controllably adjusted. The mixer and/or the nozzle may be cooled to control an exotherm generated by the reaction of the coreactive compounds.

The speed at which the coreactive composition reacts to form the thermoset polymeric matrix can be determined and/or controlled the selection of the reactive functional groups of the coreactive compounds. The reaction speed can also be determined by factors that lower the activation energy of the reaction such as heat and/or catalysts.

Reaction rates can be reflected in the gel time of a coreactive composition. A fast curing chemistry refers to a chemistry in which the coreactive compounds have a gel time such as less than 30 minutes, less than 20 minutes, less than 10 minutes, less than 5 minutes, less than 4 minutes, less than 3 minutes, less than 2 minutes, less than 1 minute, less than 45 seconds, less than 30 seconds, less than 15 seconds, or less than 5 seconds. A coreactive composition can have a gel time such as from 0.1 seconds to 5 minutes, from 0.2 seconds to 3 minutes, from 0.5 seconds to 2 minutes, from 1 second to 1 minute, or from 2 seconds to 40 seconds. Gel time is the time following mixing the coreactive components when the coreactive composition is no longer stirrable by hand. A gel time of a latent coreactive composition refers to the time from when the curing reaction is first initiated until the coreactive composition is no longer stirrable by hand.

Because the coreactive components can be uniformly combined and mixed a coreactive composition can begin to cure immediately upon mixing, the dimensions of the coreactive composition and the extrudate that is forced through the nozzle is not particularly limited. Thus, coreactive additive manufacturing facilitates the use of large dimension extrudates, which facilitates the ability to rapidly fabricate both small and large seal caps.

Using coreactive three-dimensional printing methods, coreactive compositions can be deposited at speeds from 1 mm/sec to 400 mm/sec and/or at flow rates from 0.1 mL/min to 20,000 mL/min.

### ASPECTS OF THE INVENTION

The disclosure can be further defined by one or more of the following aspects.

Aspect 1. An additively manufactured sealing component, comprising: an elongated body having: a first crescent recess and a second crescent recess opposite from the first crescent recess, the first crescent recess and the second crescent recess defining a center line; a first volume on a first side of the center line; a second volume on a second side of the center line; and a third volume between the first crescent recess and the second crescent recess such that the center line runs through the third volume; wherein the first crescent recess is outlined by a first crescent recess opening, a first tip section of the first volume, a second tip section of the second volume, and a first wall of the third volume; wherein the second crescent recess is outlined by a second crescent recess opening, a third tip section of the first volume, a fourth tip section of the second volume, and a second wall of the third volume; wherein the elongated body comprises a thermoset polymer formed by: forming a coreactive mixture by at least mixing at least a first co-reactive component and a second co-reactive component; depositing the reactive mixture layer-by-layer to form the elongated body; and curing the deposited reactive mixture via an actinic radiation source.

Aspect 2. The additively manufactured sealing component of aspect 1, wherein the first crescent recess and the second crescent recess are configured to each receive a panel having a thickness of one to ten times the size of the recess openings of the crescent recesses.

Aspect 3. The additively manufactured sealing component of any of aspects 1-2, wherein the first crescent recess and the second crescent recess extend the entire length of the elongated body.

Aspect 4. The additively manufactured sealing component of any of aspects 1-3, wherein substantial portion of the elongated body has a uniform cross-sectional geometry.

Aspect 5. The additively manufactured sealing component of any of aspects 1-4, wherein the elongated body has a porous structure.

Aspect 6. The additively manufactured sealing component of any of aspects 1-5, wherein the first crescent recess and the second crescent recess are triangular.

Aspect 7. The additively manufactured sealing component of any of aspects 1-6, wherein: the first crescent recess is configured such that upon receiving a panel having a thickness greater than the first crescent recess opening, the first tip section, the second tip section, and the first wall secure the panel via a three-point-contact; and the second crescent recess is configured such that upon receiving a panel having a thickness greater than the second crescent recess opening, the third tip section, the fourth tip section, and the second wall secure the panel via a three-point-contact.

Aspect 8. The additively manufactured sealing component of any of aspects 1-7, wherein: the first crescent recess is configured such that upon receiving a panel having a thickness greater than the first crescent recess opening, the first tip section and the second tip section elastically deform to widen the first crescent recess opening; and the second crescent recess is configured such that upon receiving a panel having a thickness greater than the second crescent recess opening, the third tip section and the fourth tip section elastically deform to widen the second crescent recess opening.

Aspect 9. The additively manufactured sealing component of any of aspects 1-8, wherein the third volume is compressible at least along the center line such that the distance between the first crescent recess and a second crescent recess is reduced when the third volume is compressed.

Aspect 10. The additively manufactured sealing component of any of aspects 1-9, wherein the elongated body is configured to receive a first panel in the first crescent recess and a second panel in the second crescent recess; and wherein the distance between the first crescent recess and the second crescent recess is variable at least a minimum of twice a wall thickness of the sealing component.

Aspect 11. The additively manufactured sealing component of any of aspects 1-10, wherein the first co-reactive component includes a sulfur-containing prepolymer.

Aspect 12. The additively manufactured sealing component of aspect 11, wherein the sulfur-containing prepolymer comprises a polythioether, a polysulfide, a sulfur-containing polyformal, a monosulfide, or a combination of any of the foregoing.

Aspect 13. The additively manufactured sealing component of aspect 12, wherein the polythioether is a thiol-terminated polythioether.

Aspect 14. The additively manufactured sealing component of any of aspects 1-13, wherein the second co-reactive component includes a polyene prepolymer.

Aspect 15. The additively manufactured sealing component of aspect 14, wherein the polyene prepolymer is a polyvinyl ether.

Aspect 16. The additively manufactured sealing component of any of aspects 1-15, wherein at least one of the first co-reactive component and the second co-reactive component further includes flame retardant filler particles.

Aspect 17. The additively manufactured sealing component of any of aspects 1-16, wherein at least one of the first co-reactive component and the second co-reactive component further includes rheology-modifying filler particles.

Aspect 18. The additively manufactured sealing component of aspect 17, wherein the rheology-modifying filler particles includes organic filler particles or inorganic filler particles.

Aspect 19. The additively manufactured sealing component of any of aspects 1-18, wherein at least one of the first co-reactive component and the second co-reactive component further includes lightweighting filler particles.

Aspect 20. The additively manufactured sealing component of any of aspects 1-19, wherein at least one of the first co-reactive component and the second co-reactive component further includes sound dampening filler particles.

Aspect 21. An aircraft component comprising: a first panel; a second panel; and an elongated seal component having: a first crescent recess and a second crescent recess opposite from the first crescent recess, the first crescent recess and the second crescent recess defining a center line, the first crescent recess securely coupled to the first panel, the second crescent recess securely coupled to the second panel; a first volume on a first side of the center line; a second volume on a second side of the center line; and a third volume between the first crescent recess and the second crescent recess such that the center line runs through the third volume; wherein the first crescent recess is outlined by a first crescent recess opening, a first tip section of the first volume, a second tip section of the second volume, and a first wall of the third volume; wherein the second crescent recess is outlined by a second crescent recess opening, a third tip section of the first volume, a fourth tip section of the second volume, and a second wall of the third volume; wherein the elongated seal component comprises a thermoset polymer formed by: forming a reactive mixture by at least mixing at least a first co-reactive component and a second co-reactive component, the first co-reactive component including a thiol-terminated polythioether, the second co-reactive component including a polyvinyl ether; depositing the reactive mixture layer-by-layer to form the elongated seal component; and curing the deposited reactive mixture via an actinic radiation source.

Aspect 22. The aircraft component of aspect 21, wherein the first crescent recess and the second crescent recess are configured to each receive a panel having a thickness of one to ten times the size of the recess openings of the crescent recesses.

Aspect 23. The aircraft component of any of aspects 21-22, wherein the first crescent recess and the second crescent recess extend the entire length of the elongated body.

Aspect 24. The aircraft component of any of aspects 21-23, wherein substantial portion of the elongated body has a uniform cross-sectional geometry.

Aspect 25. The aircraft component of any of aspects 21-24, wherein the elongated body has a porous structure.

Aspect 26. The aircraft any of aspects 21-25, wherein the first crescent recess and the second crescent recess are triangular.

Aspect 27. The aircraft of any of aspects 21-26, wherein: the first crescent recess is configured such that upon receiving a panel having a thickness greater than the first crescent recess opening, the first tip section, the second tip section, and the first wall secure the panel via a three-point-contact; and the second crescent recess is configured such that upon receiving a panel having a thickness greater than the second crescent recess opening, the third tip section, the fourth tip section, and the second wall secure the panel via a three-point-contact.

Aspect 28. The aircraft of any of aspects 21-27, wherein: the first crescent recess is configured such that upon receiving a panel having a thickness greater than the first crescent recess opening, the first tip section and the second tip section elastically deform to widen the first crescent recess opening; and the second crescent recess is configured such that upon receiving a panel having a thickness greater than the second crescent recess opening, the third tip section and the fourth tip section elastically deform to widen the second crescent recess opening.

Aspect 29. The aircraft component of any of aspects 21-28, wherein the third volume is compressible at least along the center line such that the distance between the first crescent recess and a second crescent recess is reduced when the third volume is compressed.

Aspect 30. The aircraft component of any of aspects 21-29, wherein the distance between the first crescent recess and the second crescent recess is at least a minimum of twice a wall thickness of the sealing component.

Aspect 31. The aircraft component of any of aspects 21-30, wherein the first co-reactive component includes a sulfur-containing prepolymer.

Aspect 32. The aircraft component of aspect 31, wherein the sulfur-containing prepolymer comprises a polythioether, a polysulfide, a sulfur-containing polyformal, a monosulfide, or a combination of any of the foregoing.

Aspect 33. The aircraft component of aspect 32, wherein the polythioether is a thiol-terminated polythioether.

Aspect 34. The aircraft component of any of aspects 21-33, wherein the second co-reactive component includes a polyene prepolymer.

Aspect 35. The aircraft component of aspect 34, wherein the polyene prepolymer is a polyvinyl ether.

Aspect 36. The aircraft component of any of aspects 21-35, wherein at least one of the first co-reactive component and the second co-reactive component further includes flame retardant filler particles.

Aspect 37. The aircraft component of any of aspects 21-36, wherein at least one of the first co-reactive component and the second co-reactive component further includes rheology-modifying filler particles.

Aspect 38. The aircraft component of aspect 37, wherein the rheology-modifying filler particles includes organic filler particles or inorganic filler particles.

Aspect 39. The aircraft component of any of aspects 21-38, wherein at least one of the first co-reactive component and the second co-reactive component further includes lightweighting filler particles.

Aspect 40. The aircraft component of any of aspects 21-39, wherein at least one of the first co-reactive component and the second co-reactive component further includes sound dampening filler particles.

Aspect 41. A method of additively manufacturing a sealing component, comprising: conveying a first co-reactive component and a second co-reactive component into a mixing chamber, the first co-reactive component including a thiol-terminated polythioether, the second co-reactive component including a polyvinyl ether; mixing the first co-reactive component and the second co-reactive component to form a reactive mixture; depositing the reactive mixture layer-by-layer to form an elongated body; and curing the deposited reactive mixture via an actinic radiation source; wherein the elongated body includes: a first crescent recess and a second crescent recess opposite from the first crescent recess, the first crescent recess and the second crescent recess defining a center line; a first volume on a first side of the center line; a second volume on a second side of the center line; and a third volume between the first crescent recess and the second crescent recess such that the center line runs through the third volume; wherein the first crescent recess is outlined by a first crescent recess opening, a first tip section of the first volume, a second tip section of the second volume, and a first wall of the third volume; wherein the second crescent recess is outlined by a second crescent recess opening, a third tip section of the first volume, a fourth tip section of the second volume, and a second wall of the third volume.

Aspect 42. The method of aspect 41, wherein the first crescent recess and the second crescent recess are configured to each receive a panel having a thickness of one to ten times the size of the recess openings of the crescent recesses.

Aspect 43. The method of any of aspects 41-42, wherein the first crescent recess and the second crescent recess extend the entire length of the elongated body.

Aspect 44. The method of any of aspects 41-43, wherein substantial portion of the elongated body has a uniform cross-sectional geometry.

Aspect 45. The method of any of aspects 41-44, wherein the elongated body has a porous structure.

Aspect 46. The method any of aspects 41-45, wherein the first crescent recess and the second crescent recess are triangular.

Aspect 47. The method of any of aspects 41-46, wherein: the first crescent recess is configured such that upon receiving a panel having a thickness greater than the first crescent recess opening, the first tip section, the second tip section, and the first wall secure the panel via a three-point-contact; and the second crescent recess is configured such that upon receiving a panel having a thickness greater than the second crescent recess opening, the third tip section, the fourth tip section, and the second wall secure the panel via a three-point-contact.

Aspect 48. The method of any of aspects 41-47, wherein: the first crescent recess is configured such that upon receiving a panel having a thickness greater than the first crescent recess opening, the first tip section and the second tip section elastically deform to widen the first crescent recess opening; and the second crescent recess is configured such that upon receiving a panel having a thickness greater than the second crescent recess opening, the third tip section and the fourth tip section elastically deform to widen the second crescent recess opening.

Aspect 49. The method of any of aspects 41-48, wherein the third volume is compressible at least along the center line such that the distance between the first crescent recess and a second crescent recess is reduced when the third volume is compressed.

Aspect 50. The method of any of aspects 41-49, wherein the elongated body is configured to receive a first panel in the first crescent recess and a second panel in the second crescent recess; and wherein the distance between the first crescent recess and the second crescent recess is variable at least from a minimum of twice a wall thickness of the sealing component.

Aspect 51. The method of any of aspects 41-50, wherein the first co-reactive component includes a sulfur-containing prepolymer.

Aspect 52. The method of aspect 51, wherein the sulfur-containing prepolymer comprises a polythioether, a polysulfide, a sulfur-containing polyformal, a monosulfide, or a combination of any of the foregoing.

Aspect 53. The method of aspect 52, wherein the polythioether is a thiol-terminated polythioether.

Aspect 54. The method of any of aspects 41-53, wherein the second co-reactive component includes a polyene prepolymer.

Aspect 55. The method of aspect 54, wherein the polyene prepolymer is a polyvinyl ether.

Aspect 56. The method of any of aspects 41-55, wherein at least one of the first co-reactive component and the second co-reactive component further includes flame retardant filler particles.

Aspect 57. The method of any of aspects 41-56, wherein at least one of the first co-reactive component and the second co-reactive component further includes rheology-modifying filler particles.

Aspect 58. The method of aspect 57, wherein the rheology-modifying filler particles includes organic filler particles or inorganic filler particles.

Aspect 59. The method of any of aspects 41-58, wherein at least one of the first co-reactive component and the second co-reactive component further includes lightweighting filler particles.

Aspect 60. The method of any of aspects 41-59, wherein at least one of the first co-reactive component and the second co-reactive component further includes sound dampening filler particles.

Aspect 61. A composition of matter comprising: a first co-reactive component including a sulfur-containing prepolymer; a second co-reactive component including a polyene prepolymer, the second co-reactive component reactive with the first co-reactive component upon mixing and exposure to an actinic radiation source; and flame retardant filler particles dispersed in composition of matter.

Aspect 62. The composition of aspect 61, when casted at a thickness of 0.125 inch and cured, has a tensile strength from 310 to 360 psi.

### EXAMPLES

Embodiments provided by the present disclosure are further illustrated by reference to the following examples, which describe additively manufactured linear sealing components, methods of additively manufacturing linear sealing components, and coreactive compositions for additively manufacturing linear sealing components. It will be apparent to those skilled in the art that many modifications, both to materials, and methods, may be practiced without departing from the scope of the disclosure.

### Examples 1

### UV-Cured Polythioether Linear Sealing Component

A linear sealing component was 3D printed using an actinic radiation-curable thiol-ene based resin formulation. Specifically, linear sealing component according to example 1 was produced using formulation described in Example 5 and has the same structural design as linear sealing component 200 of FIG. 2A.

The thiol-ene formulation included a mixture of thiol-terminated and alkenyl-terminated resins, rheological modifiers and fillers, and photo-initiators. The formulation was stored in UV opaque tubes at −40° C. and thawed to 23° C. before use. The thiol-ene formulation was 3D printed using a custom-built 3D printer consisting of a LulzBot Taz 3D printing gantry and print bed integrated with a ViscoTec Preeflow® Eco-DUO dual extruder. A UV source (UltraFire® WF-501B UV LED flashlight with a nominal peak wavelength of 395 nm) was mounted on the ViscoTec extruder and directed toward the point of application from the extruder at a distance of 23 inch from the extruder.

The thiol and alkenyl components were loaded into opaque Nordson cartridges, which were connected to the ViscoTec extruder using polytetrafluoroethylene tubes wrapped with aluminum foil to prevent penetration of ambient light. The loaded cartridges were pressurized to 80 psi (0.551 N/mm²) under nitrogen and printed using a custom-written G-code that simultaneously directed the print head and the print bed while toggling flow of the coreactive composition formed by mixing the thiol and alkenyl components through the ViscoTec extruder.

After extrusion was initiated, the UV LED light was switched on. The liquid thiol-ene formulations were extruded through a static mixing nozzle with an inner diameter of 0.6 mm onto the print bed. The linear sealing components were printed using a print head speed of 120 mm/s and a flow rate of 1.2 mL/min. Under these conditions the extruded coreactive composition cured within 5 sec after exiting the extruder.

### Example 2

### Acoustic Testing

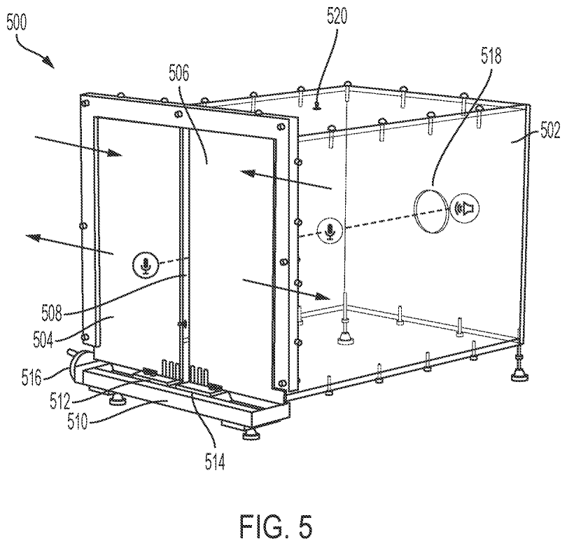

FIG. 5 shows an acoustic testing apparatus 500 used to conduct sound dampening performance testing on linear sealing components. As shown, acoustic testing apparatus 500 includes a sound chamber 502 having a first panel 504 and a second panel 506 on a first side of the sound chamber. The first panel 504 and the second panel are configured to be adjusted to form a panel gap between them of various gap sizes. Gap size may be adjusted by turning the adjustment knob 516 coupled to the linear slide 510. Specifically, the first panel 504 may be coupled to a linear slide 510 via a first slider 512 to which the first panel is coupled. The second panel 506 may be coupled to the linear slide 510 via a second slider 514 to which the second panel is coupled. The sound chamber 502 further has a sound source opening 518 and a microphone opening 520. The sound source opening 518 may allow a sound source (e.g., a speaker) to be positioned at the sound source opening to deliver sound in the sound chamber 502. The microphone opening 520 may allow a microphone to be positioned inside of the sound chamber 502 to measure sound pressure level(s) inside of the sound chamber. A sound intensity probe is then placed outside of the sound chamber near the panel gap.

Since the chamber, including the adjustable panels, is constructed with aluminum panels, the panel gap simulates a noise leakage area, such as in an aircraft cabin environment, and by inserting the linear sealing component in the panel gap, the acoustic insertion loss performance may be measured. To perform acoustic dampening test, a linear sealing component is installed between the panels, sound source is activated to deliver sound pressure into the sound chamber, the first microphone then makes a first measurement(s) corresponding to noise levels within the chamber while the sound intensity probe makes a second measurement(s) corresponding to noise levels outside the chamber. The testing conditions of Example 2 includes a 18 inch by 12 inch by 12 inch sound chamber having the adjustable gap adjusted to ⅛ inch between two ⅛ inch aluminum panels. The sound source was set to create noise up to 25.6 kHz at random and at constant level. The sound intensity probe was placed centrally next to the linear sealing component inside of the sound chamber. The sound intensity probe was placed centrally next to the linear sealing component outside of the sound chamber, approximately 2 inches apart from the panel gap. The sound intensity probe may include two microphones configured to detect measure pressure levels at frequencies of 50 Hz to 12.5 kHz (⅓^{rd} octave bands). The sound intensity probe may measure at an average 16 second/point. The environment of the sound test was at room temperature and within an anechoic room.

### Example 3

### Sound Pressure Level Frequency Spectrum

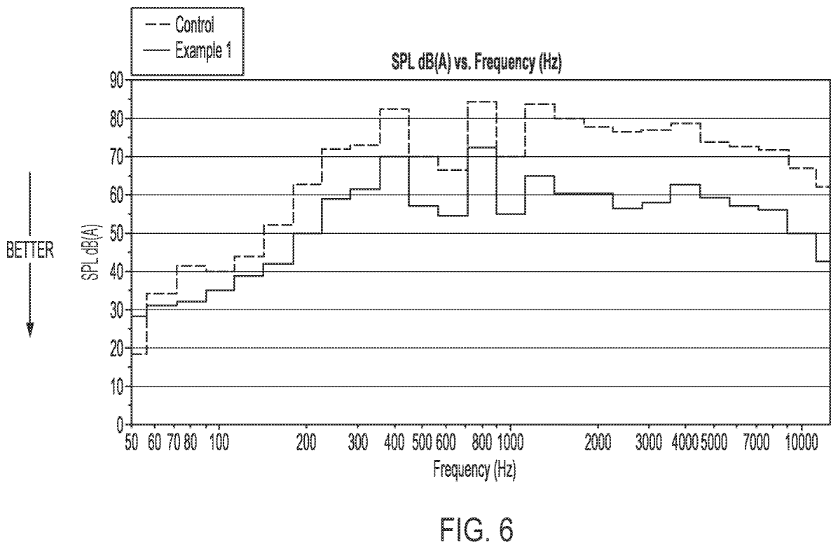

FIG. 6 shows a sound pressure level frequency spectrum from 50 Hz to 12.5 kHz, ⅓^{rd} octave bands for an open gap configuration and with the gap sealed with linear sealing component according to Example 1. As shown, high insertion loss, which may be determined by calculating the difference between the sound pressure levels measured under the open gap configuration and the sealed gap configurations, was observed for the linear sealing component of Example 1 throughout the frequency spectrum.

### Example 4

Overall Sound Pressure Level with and without a Sealer

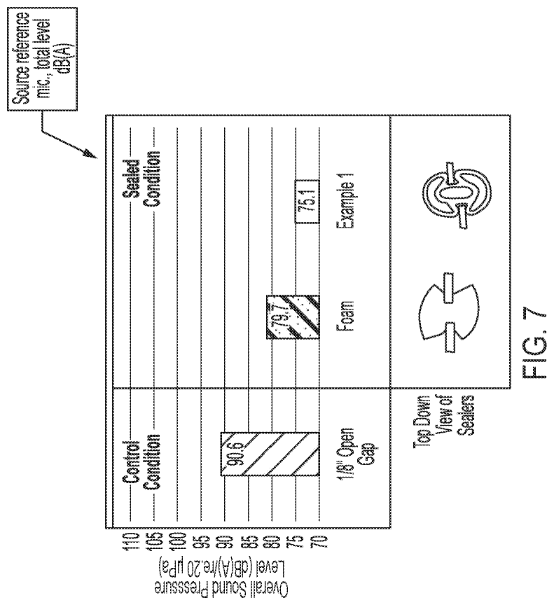

FIG. 7 shows a comparison histogram showing reduction in overall sound pressure levels without and with a sealer. A sound pressure level from the source reference was measured by the microphone within the sound chamber. As shown, the overall sound pressure level outside of the sound chamber with an open gap at a width of ⅛ inch was 90.6 dB(A). Whereas after installing a generic foam sealer, the overall sound pressure level outside of the sound chamber is reduced to 79.7 dB(A). With a linear sealing component according to Example 1 installed, the overall sound pressure level outside of the sound chamber is reduced to 75.1 dB(A).

### UV-Curable Polythioether Chemistry

Actinic radiation-curable thiol-ene based coreactive compositions were prepared by combining a first component (i.e., Part A) and a second component (i.e., Part B).

The thiol-ene based coreactive compositions may cure, at least partially, under ambient conditions without actinic radiation, which may help extruded compositions to withstand its weight during layer-by-layer extrusion and/or during subsequent actinic radiation. Such multi-cure property of the thiol-ene based coreactive compositions may help achieve covalent bonding throughout an 3D printed part.

The thiol-ene formulations included mixtures of thiol-terminated and alkenyl-terminated resins, rheological modifiers and fillers, and photo-initiators.

TABLE 1
Example 5

| | |
|---|---|
| Component | Weight % |

Part A Composition

| | |
|---|---|
| CYCLOHEXANEDIMETHANOL | 66.61 |
| DIVINYL-ETHER | |
| 4-Hydroxybutyl vinyl ether | 9.16 |
| Darocur TPO | 0.3 |
| Irgacure 651 | 1.2 |
| Hydroxyl terminated Polybutadiene resin (POLY | 8.11 |
| BD R45HTLO) | |
| Precipitated Calcium Carbonate (Socal 31) | 0.87 |
| Treated Fumed silica (Cab-o-sil TS720) | 9.76 |
| Treated Fumed silica (Aerosil R202) | 3.99 |

Part B Composition

| | |
|---|---|
| Polythioether prepolymer (2.2 functional) | 57.39 |
| Polythioether prepolymer (2.8 functional) | 13.85 |
| Trifunctional polythiol | 2.49 |
| Micronized oxidized polyethylene (Acumist A6) | 5.38 |
| Fumed silica (Cab-o-sil M5) | 1.94 |
| Treated Fumed silica (Aerosil R202) | 2.22 |
| Silica gel/amorphous silica (Gasil IJ35) | 16.35 |
| Low-density filler (Expancel 920 DE40 D30) | 0.25 |
| (3-Mercaptopropyl)trimethoxy silane | 0.13 |

The thiol-ene formulation of Example 5 was created with a Part B to Part A mixing ratio of 100 to 8.37.

TABLE 2
Example 6

| | |
|---|---|
| Component | Weight % |

Part A Composition

| | |
|---|---|
| CYCLOHEXANEDIMETHANOL | 66.61 |
| DIVINYL-ETHER | |
| 4-Hydroxybutyl vinyl ether | 9.16 |
| Darocur TPO | 0.3 |
| Irgacure 651 | 1.2 |
| Hydroxyl terminated Polybutadiene resin | 8.11 |
| (POLY BD R45HTLO) | |
| Precipitated Calcium Carbonate (Socal 31) | 0.87 |
| Treated Fumed silica (Cab-o-sil TS720) | 9.76 |
| Treated Fumed silica (Aerosil R202) | 3.99 |

Part B Composition

| | |
|---|---|
| Polythioether prepolymer (2.2 functional) | 55.21 |
| Polythioether prepolymer (2.8 functional) | 13.32 |
| Trifunctional polythiol | 2.4 |
| Micronized oxidized polyethylene (Acumist A6) | 5.18 |
| Fumed silica (Cab-o-sil M5) | 1.87 |
| Treated Fumed silica (Aerosil R202) | 2.14 |
| Silica gel/amorphous silica (Gasil IJ35) | 9.62 |
| Fine grained Ammonium Polyphosphate flame | 9.91 |
| retardant (Exolit AP 422) | |
| Low-density filler (Expancel 920 DE40 D30) | 0.24 |
| (3-Mercaptopropyl)trimethoxy silane | 0.13 |

The thiol-ene formulation of Example 6 was created with a Part B to Part A mixing ratio of 100 to 8.05.

TABLE 3
Example 7

| | |
|---|---|
| Component | Weight % |

Part A Composition

| | |
|---|---|
| CYCLOHEXANEDIMETHANOL | 66.61 |
| DIVINYL-ETHER | |
| 4-Hydroxybutyl vinyl ether | 9.16 |
| Darocur TPO | 0.3 |
| Irgacure 651 | 1.2 |
| Hydroxyl terminated Polybutadiene resin (POLY | 8.11 |
| BD R45HTLO) | |
| Precipitated Calcium Carbonate (Socal 31) | 0.87 |
| Treated Fumed silica (Cab-o-sil TS720) | 9.76 |
| Treated Fumed silica (Aerosil R202) | 3.99 |

Part B Composition

| | |
|---|---|
| Polythioether prepolymer (2.2 functional) | 55.21 |
| Polythioether prepolymer (2.8 functional) | 13.32 |
| Trifunctional polythiol | 2.4 |
| Micronized oxidized polyethylene (Acumist A6) | 5.18 |
| Fumed silica (Cab-o-sil M5) | 1.87 |
| Treated Fumed silica (Aerosil R202) | 2.14 |
| Silica gel/amorphous silica (Gasil IJ35) | 9.62 |
| Ammonium Polyphosphate flame retardant | 9.91 |
| (Exolit AP 740) | |
| Low-density filler (Expancel 920 DE40 D30) | 0.24 |
| (3-Mercaptopropyl)trimethoxy silane | 0.13 |

The thiol-ene formulation of Example 7 was created with a Part B to Part A mixing ratio of 100 to 8.05.

TABLE 4
Example 8

| | |
|---|---|
| Component | Weight % |

Part A Composition

| | |
|---|---|
| CYCLOHEXANEDIMETHANOL | 66.61 |
| DIVINYL-ETHER | |
| 4-Hydroxybutyl vinyl ether | 9.16 |
| Darocur TPO | 0.3 |
| Irgacure 651 | 1.2 |
| Hydroxyl terminated Polybutadiene resin (POLY | 8.11 |
| BD R45HTLO) | |
| Precipitated Calcium Carbonate (Socal 31) | 0.87 |
| Treated Fumed silica (Cab-o-sil TS720) | 9.76 |
| Treated Fumed silica (Aerosil R202) | 3.99 |

Part B Composition

| | |
|---|---|
| Polythioether prepolymer (2.2 functional) | 51.87 |
| Polythioether prepolymer (2.8 functional) | 12.52 |
| Trifunctional polythiol | 2.25 |
| Micronized oxidized polyethylene (Acumist A6) | 4.86 |
| Fumed silica (Cab-o-sil M5) | 1.75 |
| Treated Fumed silica (Aerosil R202) | 2.01 |
| Silica gel/amorphous silica (Gasil IJ35) | 9.58 |
| Fine grained Ammonium Polyphosphate flame | 14.82 |
| retardant (Exolit AP 422) | |
| Low-density filler (Expancel 920 DE40 D30) | 0.23 |
| (3-Mercaptopropyl)trimethoxy silane | 0.12 |

The thiol-ene formulation of Example 8 was created with a Part B to Part A mixing ratio of 100 to 7.57.

TABLE 5
Example 9

| | |
|---|---|
| Component | Weight % |

Part A Composition

| | |
|---|---|
| CYCLOHEXANEDIMETHANOL | 66.61 |
| DIVINYL-ETHER | |
| 4-Hydroxybutyl vinyl ether | 9.16 |
| Darocur TPO | 0.3 |
| Irgacure 651 | 1.2 |
| Hydroxyl terminated Polybutadiene resin (POLY | 8.11 |
| BD R45HTLO) | |
| Precipitated Calcium Carbonate (Socal 31) | 0.87 |
| Treated Fumed silica (Cab-o-sil TS720) | 9.76 |
| Treated Fumed silica (Aerosil R202) | 3.99 |

Part B Composition

| | |
|---|---|
| Polythioether prepolymer (2.2 functional) | 51.87 |
| Polythioether prepolymer (2.8 functional) | 12.52 |
| Trifunctional polythiol | 2.25 |
| Micronized oxidized polyethylene (Acumist A6) | 4.86 |
| Fumed silica (Cab-o-sil M5) | 1.75 |
| Treated Fumed silica (Aerosil R202) | 2.01 |
| Silica gel/amorphous silica (Gasil IJ35) | 9.58 |
| Ammonium Polyphosphate flame retardant (Exolit | 14.82 |
| AP 740) | |
| Low-density filler (Expancel 920 DE40 D30) | 0.23 |
| (3-Mercaptopropyl)trimethoxy silane | 0.12 |

The thiol-ene formulation of Example 9 was created with a Part B to Part A mixing ratio of 100 to 7.57.

### Example 10

Rheological Properties of Un-Cured Coreactive Compositions from Examples 5-9

Uncured sealant formulations were measured using a 25 mm parallel plate geometry at room temperature without light exposure. Viscosity was measured from shear rate of 0.1 l/s to 200 l/s. Viscosity recovery was measured by holding the shear rate at 0.1 l/s for 200 s.

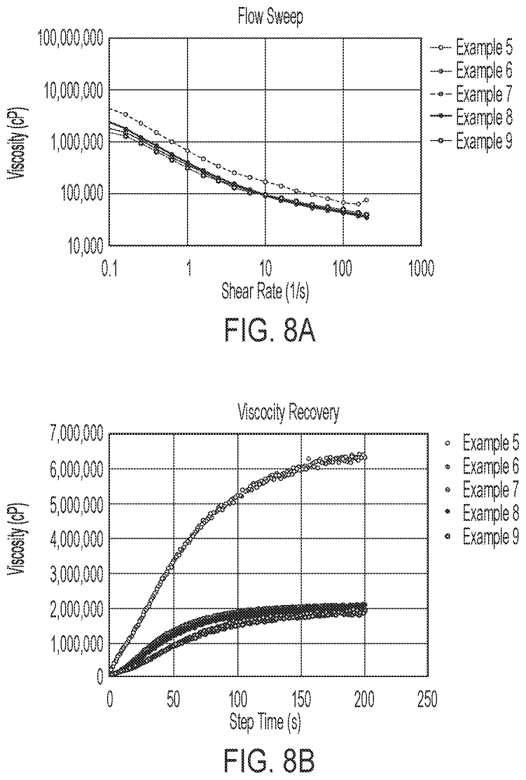

FIG. 8A shows viscosities of un-cured coreactive compositions from Examples 5-9 at a predetermined shear rate range.

FIG. 8B shows after-shear viscosities of un-cured coreactive compositions from Examples 5-9 over time.

### Example 11

TABLE 6

| | Control | Sample A | Sample B | Sample C | Sample D |
|---|---|---|---|---|---|
| Depth of Cure (mm) | 9.87 | 7.56 | 7.27 | 7.34 | 7.01 |
| Hardness (Shore A) | 45 | 37 | 40 | 36 | 35 |
| Tensile Strength (psi) | 392 +/− 17 | 318 +/− 8 | 350 +/− 21 | 333 +/− 25 | 329 +/− 6 |
| Elongation (%) | 324 +/− 14 | 443 +/− 28 | 477 +/− 41 | 456 +/− 28 | 425 +/− 23 |

Physical Properties of Coreactive Compositions from Examples 5-9

The sealants formulations were applied to a substrates to a thickness of 0.125 inches (3.175 mm). The sealants were exposed to 1 J/cm2 to 2 J/cm2 of UVA radiation. The Shore A hardness was measured according to ASTM D220 using a Type A durometer. Tensile strength and elongation were measured according to ASTM D412 Die C. Depth of cure was measured by applying the sealant formulations into a groove of 0.4 inch depth. The depth of cure is obtained by determining the depth at which the sample was fully cured after exposure.

### Example 12

TABLE 7
Flame retardant properties of cured coreactive compositions from Examples 5-9

| | Control | Sample A | Sample B | Sample C | Sample D |
|---|---|---|---|---|---|
| Burn rate | 1.27 +/− 0.21 | 0.5 +/− 0.1 | 0.73 +/− 0.12 | 0.1 +/− 0.17* | 0.23 +/− 0.4* |
| (inches/min) | | | | | |
| Flame | 4 +/− 0 | 2.47 +/− 1.36 | 2.8 +/− 1.31 | 0.2 +/− 0.35* | 1.33 +/− 2.31* |
| Time (min) | | | | | |
| Burn Length | 4.93 +/− 0.81 | 1.23 +/− 0.65 | 2.16 +/− 1.27 | 0.07 +/− 0.12* | 0.87 +/− 1.5* |
| (inches) | | | | | |

Data sets marked with an asterisk contain samples with zero values, which indicate self-extinguish condition. Results obtained in accordance with CFR 14 § 25.853(a) Appendix F Part I(a)1(iv) specification. Average burn rate to no exceed 2.5 inches/minute.

### Example 13

### Linear Sealing Component Dimensions

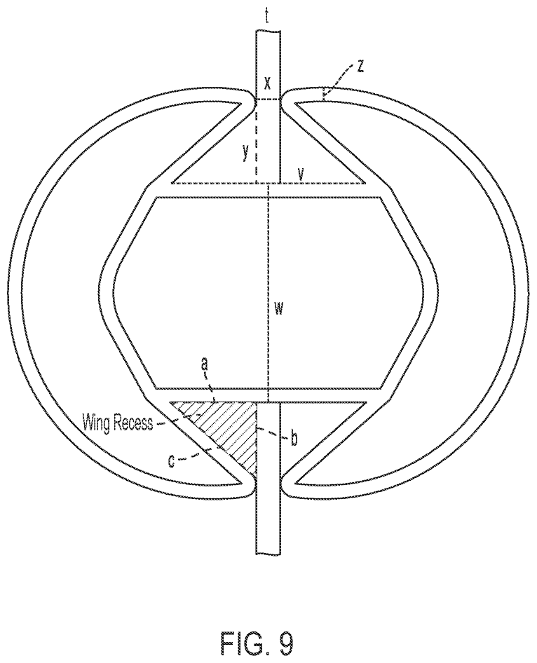

FIG. 9 is a diagram showing dimensions of a linear sealing component according to various embodiments of the present disclosure. It is to be understood that the linear sealing components of the present disclosure may be scaled up or down to be fit between panels of different thicknesses and panel gaps of different sizes. In certain examples, the relationships between the panel thickness (t), the gap size (w), the component wall thickness (z), the recess opening size (x), the recess depth (y), and the recess inner wall width (v) may be described by one or more of Formulas (14)(15)(16)(17):

$$y = 4 x \qquad ( 14 )$$

$$v = 10 x \qquad ( 15 )$$

$$2 z \leq w \qquad ( 16 )$$

$$x \leq t \leq v \qquad ( 17 )$$

In various examples, each crescent recess of a linear sealing component of the present disclosure may form two wing recesses when a corresponding crescent recess is coupled to a panel. The dimensions of the wing recess may be described by one or more of Formulas (18)(19)(20):

$$a = 5 x - ( t / 2 ) \qquad ( 18 )$$

$${c}^{2} = {( 4 x )}^{2} + {( 4.5 x )}^{2} \qquad ( 19 )$$

$${b}^{2} = {c}^{2} - {( 5 x - ( t / 2 ) )}^{2} \qquad ( 20 )$$

Finally, it should be noted that there are alternative ways of implementing the embodiments disclosed herein. Accordingly, the present embodiments are to be considered as illustrative and not restrictive. Furthermore, the claims are not to be limited to the details given herein and are entitled to their full scope and equivalents thereof.

1.-23. (canceled)

24. An additively manufactured sealing component, comprising:
an elongated body comprising:
a first recess and a second recess opposite from the first recess, the first recess and the second recess defining a center line;
a first volume on a first side of the center line;
a second volume on a second side of the center line; and
a third volume between the first recess and the second recess such that the center line runs through the third volume;
wherein the first recess is outlined by a first recess opening, a first tip section of the first volume, a second tip section of the second volume, and a first wall of the third volume;
wherein the second recess is outlined by a second recess opening, a third tip section of the first volume, a fourth tip section of the second volume, and a second wall of the third volume;
wherein the elongated body comprises a thermoset polymer formed by:
forming a coreactive mixture by at least mixing at least a first co-reactive component and a second co-reactive component;
depositing the reactive mixture layer-by-layer to form the elongated body; and
curing the deposited reactive mixture via an actinic radiation source.

25. The additively manufactured sealing component of claim 24, wherein the first recess and the second recess are configured to each receive a panel having a thickness of one to ten times the size of the recess openings of the recesses.

26. The additively manufactured sealing component of any of claim 24, wherein the first recess and the second recess extend the entire length of the elongated body.

27. The additively manufactured sealing component of any of claim 24, wherein substantial portion of the elongated body has a uniform cross-sectional geometry.

28. The additively manufactured sealing component of claim 24, wherein the elongated body has a porous structure.

29. The additively manufactured sealing component of claim 24, wherein the first recess and the second recess are triangular.

30. The additively manufactured sealing component of claim 24, wherein:
the first recess is configured such that upon receiving a panel having a thickness greater than the first recess opening, the first tip section, the second tip section, and the first wall secure the panel via a three-point-contact; and
the second recess is configured such that upon receiving a panel having a thickness greater than the second recess opening, the third tip section, the fourth tip section, and the second wall secure the panel via a three-point-contact.

31. The additively manufactured sealing component of claim 24, wherein:
the first recess is configured such that upon receiving a panel having a thickness greater than the first recess opening, the first tip section and the second tip section elastically deform to widen the first recess opening; and
the second recess is configured such that upon receiving a panel having a thickness greater than the second recess opening, the third tip section and the fourth tip section elastically deform to widen the second recess opening.

32. The additively manufactured sealing component of claim 24, wherein the third volume is compressible at least along the center line such that the distance between the first recess and a second recess is reduced when the third volume is compressed.

33. The additively manufactured sealing component of claim 24, wherein the elongated body is configured to:
receive a first panel in the first recess and a second panel in the second recess;
wherein the distance between the first recess and the second recess is variable at least a minimum of twice a wall thickness of the sealing component.

34. The additively manufactured sealing component of claim 24, wherein the first co-reactive component comprises a sulfur-containing prepolymer.

35. The additively manufactured sealing component of claim 34, wherein the sulfur-containing prepolymer comprises a polythioether, a polysulfide, a sulfur-containing polyformal, a monosulfide, or a combination of any of the foregoing.

36. The additively manufactured sealing component of claim 24, wherein the polythioether is a thiol-terminated polythioether.

37. The additively manufactured sealing component of claim 24, wherein the second co-reactive component comprises a polyene prepolymer.

38. The additively manufactured sealing component of claim 37, wherein the polyene prepolymer is a polyvinyl ether.

39. The additively manufactured sealing component of claim 24, wherein at least one of the first co-reactive component and the second co-reactive component further comprises flame retardant filler particles.

40. The additively manufactured sealing component of claim 24, wherein at least one of the first co-reactive component and the second co-reactive component further comprises sound dampening filler particles.

41. The additively manufactured sealing component of claim 24, wherein at least one of the first co-reactive component and the second co-reactive component further comprises rheology-modifying filler particles and/or light weighting particles, wherein the rheology modifying particles comprise organic filler particles or inorganic filler particles.

42. An aircraft component, comprising:
a first panel;
a second panel; and
an elongated seal component having:
a first recess and a second recess opposite from the first recess, the first recess and the second recess defining a center line, the first recess securely coupled to the first panel, the second recess securely coupled to the second panel;
a first volume on a first side of the center line;
a second volume on a second side of the center line; and
a third volume between the first recess and the second recess such that the center line runs through the third volume;
wherein the first recess is outlined by a first recess opening, a first tip section of the first volume, a second tip section of the second volume, and a first wall of the third volume;
wherein the second recess is outlined by a second recess opening, a third tip section of the first volume, a fourth tip section of the second volume, and a second wall of the third volume;
wherein the elongated seal component comprises a thermoset polymer formed by:
forming a reactive mixture by at least mixing at least a first co-reactive component and a second co-reactive component, the first co-reactive component comprising a thiol-terminated polythioether, the second co-reactive component including a polyvinyl ether;
depositing the reactive mixture layer-by-layer to form the elongated seal component; and
curing the deposited reactive mixture via an actinic radiation source.

43. A method of additively manufacturing a sealing component, comprising:
conveying a first co-reactive component and a second co-reactive component into a mixing chamber, the first co-reactive component comprising a thiol-terminated polythioether, the second co-reactive component comprising a polyvinyl ether;
mixing the first co-reactive component and the second co-reactive component to form a reactive mixture;
depositing the reactive mixture layer-by-layer to form an elongated body; and
curing the deposited reactive mixture via an actinic radiation source;
wherein the elongated body comprises:
a first recess and a second recess opposite from the first recess, the first recess and the second recess defining a center line;
a first volume on a first side of the center line;
a second volume on a second side of the center line; and
a third volume between the first recess and the second recess such that the center line runs through the third volume;
wherein the first recess is outlined by a first recess opening, a first tip section of the first volume, a second tip section of the second volume, and a first wall of the third volume;
wherein the second recess is outlined by a second recess opening, a third tip section of the first volume, a fourth tip section of the second volume, and a second wall of the third volume.
